(19) United States
(12) Patent Application Publication
(10) Pub. No.: US 2017/0055282 A1
(43) Pub. Date: Feb. 23, 2017

(54) CONNECTION SETUP IN "DEVICE-TO-DEVICE RELAYED UPLINK, DIRECT DOWNLINK" ARCHITECTURE FOR CELLULAR NETWORKS

(71) Applicant: QUALCOMM Incorporated, San Diego, CA (US)

(72) Inventors: Bilal SADIQ, Basking Ridge, NJ (US); Junyi LI, Chester, NJ (US); Navid ABEDINI, Raritan, NJ (US); Saurabha Rangrao TAVILDAR, Jersey City, NJ (US); Shailesh PATIL, Raritan, NJ (US); Sudhir Kumar BAGHEL, Bridgewater, NJ (US); Kapil GULATI, Franklin Park, NJ (US); Hao XU, San Diego, CA (US)

(21) Appl. No.: 15/212,004

(22) Filed: Jul. 15, 2016

Related U.S. Application Data
(60) Provisional application No. 62/208,101, filed on Aug. 21, 2015.

(51) Int. Cl. H04W 74/00; H04W 8/00; H04W 74/08; H04W 4/00

(52) U.S. Cl. CPC H04W 74/004; H04W 4/005; H04W 8/005; H04W 74/08; H04W 88/04

(57) ABSTRACT

A procedure to select a UE as a relay between a machine-type communication (MTC) device and a base station is desired to improve communication between the MTC device and the base station. The apparatus may be a machine-type communication user equipment (M-UE). The apparatus transmits, to one or more user equipments (UEs), an access request to request access to a base station through one or more of the one or more UEs as a relay. The apparatus receives an access request response from the base station, the access request response including selection information about selection of at least one of the one or more UEs as a relay between the M-UE and the base station.

### CROSS-REFERENCE TO RELATED APPLICATION(S)

This application claims the benefit of U.S. Provisional Application Ser. No. 62/208,101, entitled “CONNECTION SETUP IN “DEVICE-TO-DEVICE RELAYED UPLINK, DIRECT DOWNLINK” ARCHITECTURE FOR CELLULAR NETWORKS″ and filed on Aug. 21, 2015, which is expressly incorporated by reference herein in its entirety.

### BACKGROUND

Field

The present disclosure relates generally to communication systems, and more particularly, to connection setup between a base station and several user equipments.

Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to support mobile broadband access through improved spectral efficiency, lowered costs, and improved services using OFDMA on the downlink, SC-FDMA on the uplink, and multiple-input multiple-output (MIMO) antenna technology. However, as the demand for mobile broadband access continues to increase, there exists a need for further improvements in LTE technology. These improvements may also be applicable to other multi-access technologies and the telecommunication standards that employ these technologies.

In wireless communication, a device may be configured to utilize another device as a relay to communicate with a base station. There may be several factors that affect performance of communication when a device is used as a relay. Thus, such factors may be considered to improve the communication with the base station.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A machine-type communication (MTC) device may be configured to utilize a user equipment (UE) as a relay to communicate with a base station, to improve battery life of the MTC device and to reduce interference with a system involving the MTC device and the base station. In some cases, an MTC device may receive UL communication via a UE as a relay and may transmit DL communication directly to the base station without using a relay. When the MTC device utilizes a relay, multiple UEs may exist as possible relays. Therefore, a procedure to select a UE as a relay between a MTC device and a base station is desired to improve communication between the MTC device and the base station.

In an aspect of the disclosure, a method, a computer-readable medium, and an apparatus are provided. The apparatus may be a machine-type communication user equipment (M-UE). The M-UE transmits, to one or more user equipments (UEs), an access request to request access to a base station through one or more of the one or more UEs as a relay. The M-UE receives an access request response from the base station, the access request response including selection information about selection of at least one of the one or more UEs as a relay between the M-UE and the base station.

In an aspect of the disclosure, the apparatus may be an M-UE. The M-UE includes means for transmitting, to one or more UEs, an access request to request access to a base station through one or more of the one or more UEs as a relay. The M-UE includes means for receiving an access request response from the base station, the access request response including selection information about selection of at least one of the one or more UEs as a relay between the M-UE and the base station.

In an aspect of the disclosure, the apparatus may be an M-UE including a memory and at least one processor coupled to the memory. The at least one processor is configured to: transmit, to one or more UEs, an access request to request access to a base station through one or more of the one or more UEs as a relay, and receive an access request response from the base station, the access request response including selection information about selection of at least one of the one or more UEs as a relay between the M-UE and the base station.

In an aspect of the disclosure, computer-readable medium storing computer executable code for an M-UE, comprises code to: transmit, to one or more UEs, an access request to request access to a base station through one or more of the one or more UEs as a relay, and receive an access request response from the base station, the access request response including selection information about selection of at least one of the one or more UEs as a relay between the M-UE and the base station.

In an aspect of the disclosure, a method, a computer-readable medium, and an apparatus are provided. The apparatus may be a UE. The UE receives an access request from an M-UE, the access request requesting access to a base station through the UE as a relay. The UE determines whether to forward the access request to the base station. The UE forwards the access request to the base station upon determining to forward the access request to the base station.

In an aspect of the disclosure, the apparatus may be a UE. The UE includes means for receiving an access request from an M-UE, the access request requesting access to a base station through the UE as a relay. The UE includes means for determining whether to forward the access request to the base station. The UE includes means for forwarding the access request to the base station upon determining to forward the access request to the base station.

In an aspect of the disclosure, the apparatus may be a UE including a memory and at least one processor coupled to the memory. The at least one processor is configured to: receive an access request from an M-UE, the access request requesting access to a base station through the UE as a relay, determine whether to forward the access request to the base station, and forward the access request to the base station upon determining to forward the access request to the base station.

In an aspect of the disclosure, computer-readable medium storing computer executable code for a UE, comprises code to: receive an access request from an M-UE, the access request requesting access to a base station through the UE as a relay, determine whether to forward the access request to the base station, and forward the access request to the base station upon determining to forward the access request to the base station.

In an aspect of the disclosure, a method, a computer-readable medium, and an apparatus are provided. The apparatus may be a base station. The base station receives an access request from an M-UE via one or more UEs, the access request requesting access to the base station through one or more of the one or more UEs as a relay. The base station determines whether to select at least one of the one or more UEs as a relay for communication between the M-UE and the base station. The base station transmits an access request response to the M-UE, the access request response including selection information about selection of at least one of the one or more UEs as a relay for communication between the M-UE and the base station.

In an aspect, the base station further receives, from each of the one or more UEs, at least one of a reference signal received power (RSRP) or a reference signal received quality (RSRQ) of a connection between the M-UE and each of the one or more UEs, where the determining whether to select at least one of the one or more UEs as a relay includes determining to select at least one of the one or more UEs as a relay based on the at least one of the RSRP or the RSRQ of the connection between the M-UE and each of the one or more UEs. In an aspect, the determining to select the at least one of the one or more UEs as a relay is further based on at least one of a distance between the base station and each of the one or more UEs or signal strength between the base station and each of the one or more UEs. In an aspect, the base station further transmits, to the at least one selected UE of the one or more UEs, relay information indicating the at least one selected UE of the one or more UEs as the relay for communication between the M-UE and the base station. In an aspect, the relay information includes a connection identifier that is used for receiving communication from the M-UE. In an aspect, the relay information includes a radio resource control (RRC) reconfiguration message used for at least one of configuration for the at least one selected UE to relay communication from the M-UE or configuration of a connection state of a communication link between the at least one selected UE and the M-UE. In such an aspect, the RRC reconfiguration message associates a logical channel at the at least one selected UE with data from the M-UE that is being relayed to the base station. In an aspect, the determining whether to select at least one of the one or more UEs as a relay includes determining not to select the one or more UEs when each of the at least one of the RSRP or the RSRQ of the connection between the M-UE and each of the one or more UEs is below a minimum threshold.

In an aspect, the access request response is transmitted to the M-UE during a time window that is known to the M-UE. In an aspect, the selection information includes at least one of a connection identifier, the connection identifier being used for communication between the M-UE and at least one selected UE of the one or more UEs, or an indication that no UE is selected as a relay. In such an aspect, the access request response further includes at least one of: an access bar command that indicates that the M-UE should not try discovering a network or accessing the network, or a cell radio network temporary identifier (C-RNTI) of the M-UE.

In an aspect of the disclosure, the apparatus may be a base station. The base station includes means for receiving an access request from an M-UE via one or more UEs, the access request requesting access to the base station through one or more of the one or more UEs as a relay. The base station includes means for determining whether to select at least one of the one or more UEs as a relay for communication between the M-UE and the base station. The base station includes means for transmitting an access request response to the M-UE, the access request response including selection information about selection of at least one of the one or more UEs as a relay for communication between the M-UE and the base station.

In an aspect of the disclosure, the apparatus may be a base station including a memory and at least one processor coupled to the memory. The at least one processor is configured to: receive an access request from an M-UE via one or more UEs, the access request requesting access to the base station through one or more of the one or more UEs as a relay, determine whether to select at least one of the one or more UEs as a relay for communication between the M-UE and the base station, and transmit an access request response to the M-UE, the access request response including selection information about selection of at least one of the one or more UEs as a relay for communication between the M-UE and the base station.

In an aspect of the disclosure, computer-readable medium storing computer executable code for a base station, comprises code to: receive an access request from an M-UE via one or more UEs, the access request requesting access to the base station through one or more of the one or more UEs as a relay, determine whether to select at least one of the one or more UEs as a relay for communication between the M-UE and the base station, and transmit an access request response to the M-UE, the access request response including selection information about selection of at least one of the one or more UEs as a relay for communication between the M-UE and the base station.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating LTE examples of a DL frame structure, DL channels within the DL frame structure, an UL frame structure, and UL channels within the UL frame structure, respectively.

FIG. 3 is a diagram illustrating an example of an evolved Node B (eNB) and user equipment (UE) in an access network.

FIG. 4 is a diagram of a device-to-device communications system.

FIG. 5 is an example diagram illustrating a connection setup procedure for a MTC device to utilize a relay for uplink communication, according to an aspect of the disclosure.

FIG. 6 is an example flow diagram illustrating a connection setup to utilize a relay for UL communication, according to an aspect of the disclosure.

FIG. 7 is a flowchart of a method of wireless communication, according to an aspect of the disclosure.

FIG. 8 is a conceptual data flow diagram illustrating the data flow between different means/components in an exemplary apparatus.

FIG. 9 is a diagram illustrating an example of a hardware implementation for an apparatus employing a processing system.

FIG. 10 is a flowchart of a method of wireless communication, according to an aspect of the disclosure.

FIG. 11A is a flowchart of a method of wireless communication, expanding from the flowchart of FIG. 10, according to an aspect of the disclosure.

FIG. 11B is a flowchart of a method of wireless communication, expanding from the flowchart of FIG. 10, according to an aspect of the disclosure.

FIG. 12 is a conceptual data flow diagram illustrating the data flow between different means/components in an exemplary apparatus.

FIG. 13 is a diagram illustrating an example of a hardware implementation for an apparatus employing a processing system.

FIG. 14 is a flowchart of a method of wireless communication, according to an aspect of the disclosure.

FIG. 15A is a flowchart of a method of wireless communication, expanding from the flowchart of FIG. 14, according to an aspect of the disclosure.

FIG. 15B is a flowchart of a method of wireless communication, expanding from the flowchart of FIG. 14, according to an aspect of the disclosure.

FIG. 16 is a conceptual data flow diagram illustrating the data flow between different means/components in an exemplary apparatus.

FIG. 17 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

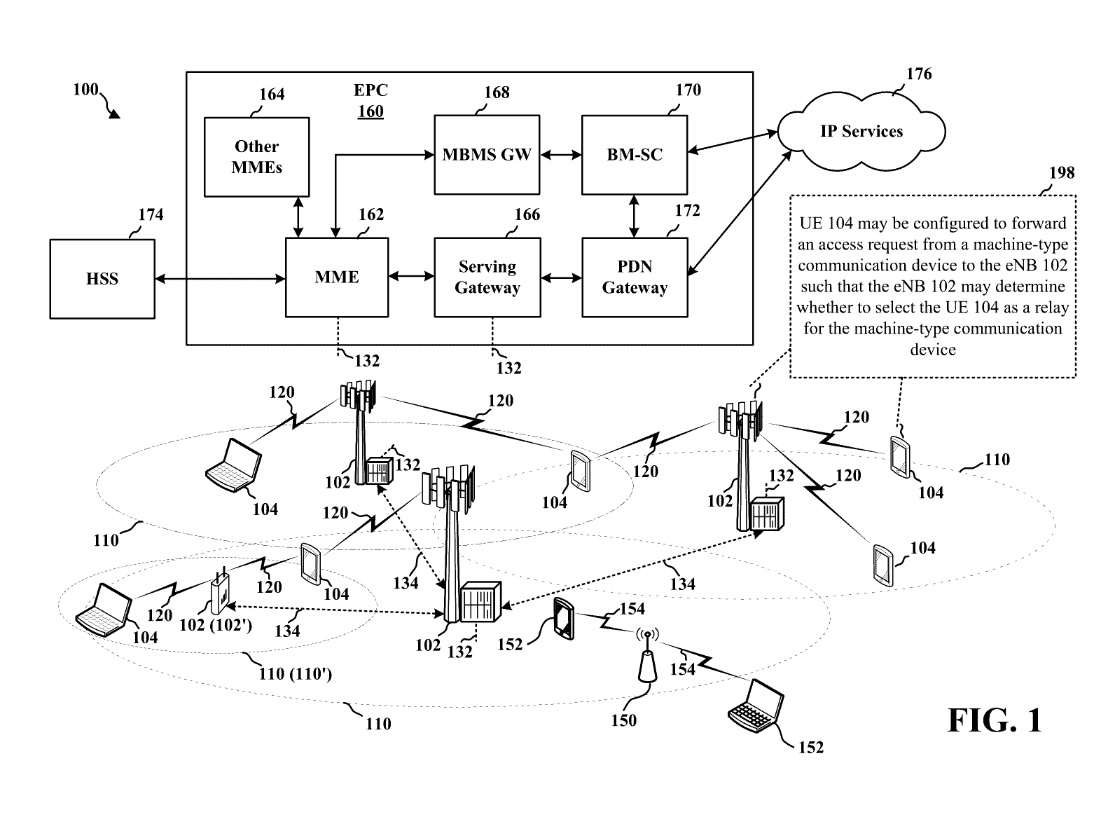

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include eNBs. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links may be through one or more carriers. The base stations 102/UEs 104 may use spectrum up to Y MHz (e.g., 5, 10, 15, 20 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ LTE and use the same 5 GHz unlicensed frequency spectrum as used by the Wi-Fi AP 150. The small cell 102′, employing LTE in an unlicensed frequency spectrum, may boost coverage to and/or increase capacity of the access network. LTE in an unlicensed spectrum may be referred to as LTE-unlicensed (LTE-U), licensed assisted access (LAA), or MuLTEfire.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, or any other similar functioning device. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to forward an access request from a machine-type communication device to the eNB 102 such that the eNB 102 may determine whether to select the UE 104 as a relay for the machine-type communication device (198).

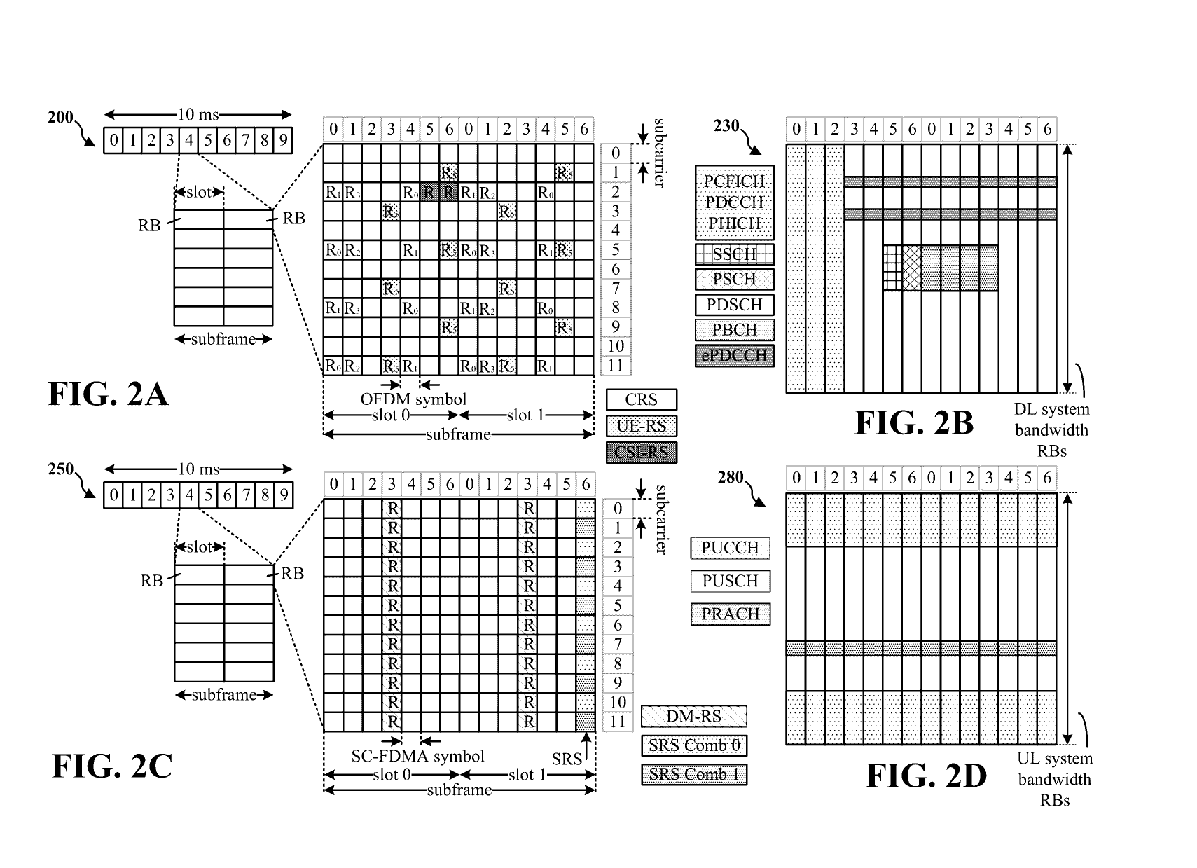

FIG. 2A is a diagram 200 illustrating an example of a DL frame structure in LTE. FIG. 2B is a diagram 230 illustrating an example of channels within the DL frame structure in LTE. FIG. 2C is a diagram 250 illustrating an example of an UL frame structure in LTE. FIG. 2D is a diagram 280 illustrating an example of channels within the UL frame structure in LTE. Other wireless communication technologies may have a different frame structure and/or different channels. In LTE, a frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). In LTE, for a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R₀, R₁, R₂, and R₃, respectively), UE-RS for antenna port 5 (indicated as R₅), and CSI-RS for antenna port 15 (indicated as R). FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) is within symbol 6 of slot 0 within subframes 0 and 5 of a frame, and carries a primary synchronization signal (PSS) that is used by a UE to determine subframe timing and a physical layer identity. The secondary synchronization channel (SSCH) is within symbol 5 of slot 0 within subframes 0 and 5 of a frame, and carries a secondary synchronization signal (SSS) that is used by a UE to determine a physical layer cell identity group number. Based on the physical layer identity and the physical layer cell identity group number, the UE can determine a physical cell identifier (PCI). Based on the PCI, the UE can determine the locations of the aforementioned DL-RS. The physical broadcast channel (PBCH) is within symbols 0, 1, 2, 3 of slot 1 of subframe 0 of a frame, and carries a master information block (MIB). The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the eNB. The UE may additionally transmit sounding reference signals (SRS) in the last symbol of a subframe. The SRS may have a comb structure, and a UE may transmit SRS on one of the combs. The SRS may be used by an eNB for channel quality estimation to enable frequency-dependent scheduling on the UL. FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

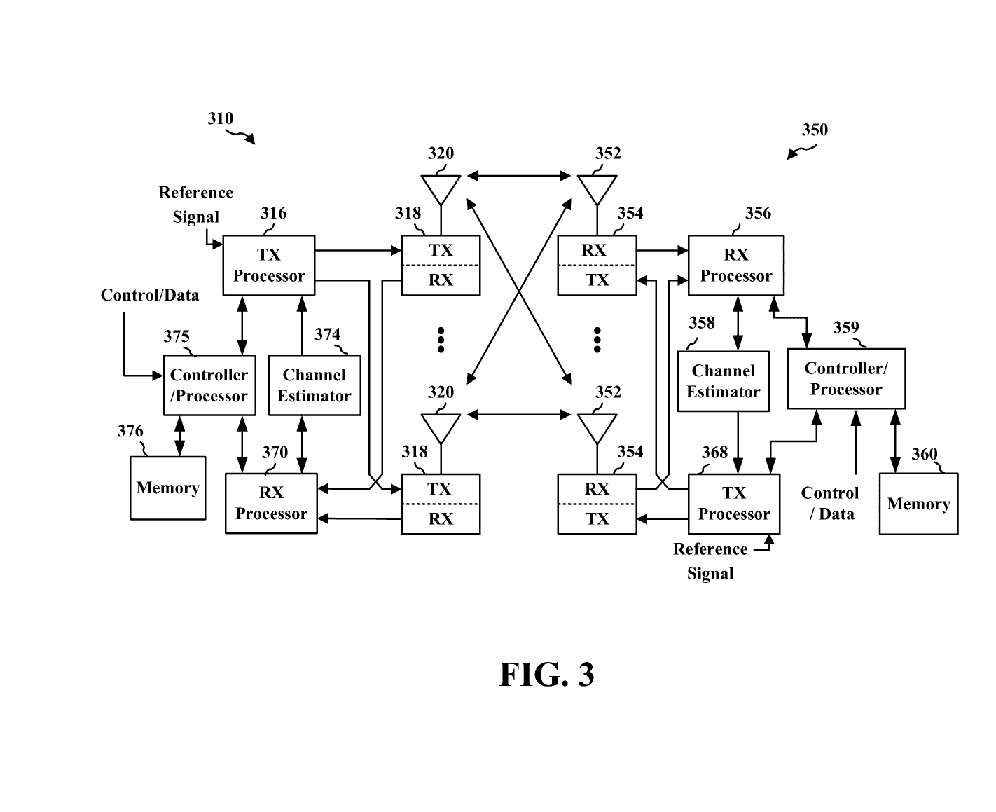

FIG. 3 is a block diagram of an eNB 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demuliplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 310. These soft decisions may be based on channel estimates computed by the channel estimator 358. The soft decisions are then decoded and deinterleaved to recover the data and control signals that were originally transmitted by the eNB 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the eNB 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demuliplexing of MAC SDUs from TBs, scheduling information reporting, error correction through HARQ, priority handling, and logical channel prioritization.

Channel estimates derived by a channel estimator 358 from a reference signal or feedback transmitted by the eNB 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the eNB 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

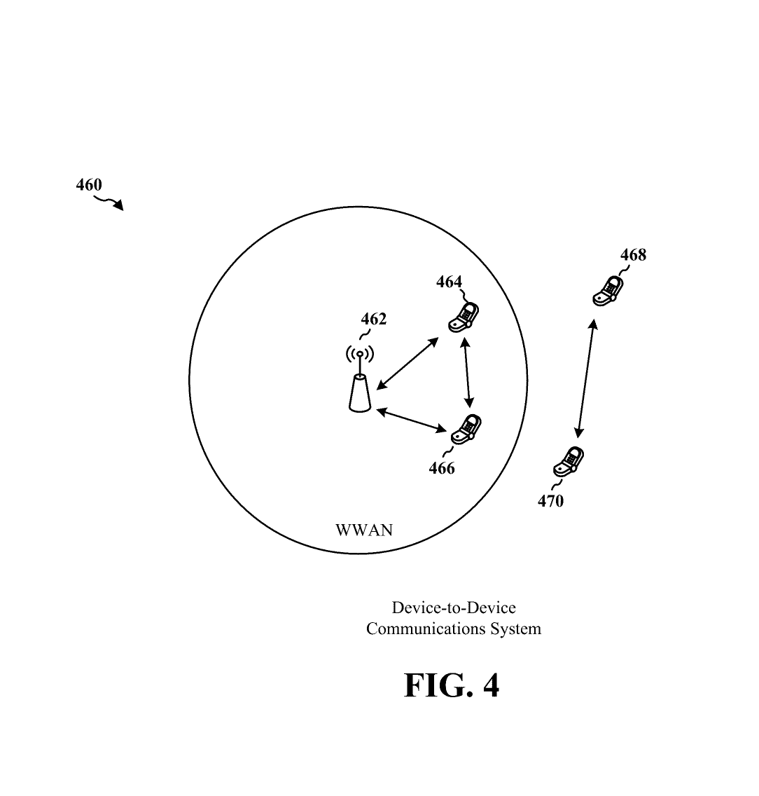

FIG. 4 is a diagram of a device-to-device (D2D) communications system 460. The D2D communications system 460 includes a plurality of UEs 464, 466, 468, 470. The D2D communications system 460 may overlap with a cellular communications system, such as for example, a WWAN. Some of the UEs 464, 466, 468, 470 may communicate together in D2D communication using the DL/UL WWAN spectrum, some may communicate with the base station 462, and some may do both. For example, as shown in FIG. 4, the UEs 468, 470 are in D2D communication and the UEs 464, 466 are in D2D communication. The UEs 464, 466 are also communicating with the base station 462. The D2D communication may be through one or more sidelink channels, such as a physical sidelink broadcast channel (PSBCH), a physical sidelink discovery channel (PSDCH), a physical sidelink shared channel (PSSCH), and a physical sidelink control channel (PSCCH).

The exemplary methods and apparatuses discussed infra are applicable to any of a variety of wireless D2D communications systems, such as for example, a wireless device-to-device communication system based on FlashLinQ, WiMedia, Bluetooth, ZigBee, or Wi-Fi based on the IEEE 802.11 standard. To simplify the discussion, the exemplary methods and apparatus are discussed within the context of LTE. However, one of ordinary skill in the art would understand that the exemplary methods and apparatuses are applicable more generally to a variety of other wireless device-to-device communication systems.

A device may utilize a UE as a relay for communication. For example, a device may communicate with a base station via a UE (e.g., a relay UE) being utilized as a relay between the device and the base station. Such a feature of utilizing a UE as a relay may be applied to machine-type communication (MTC) systems. In particular, an MTC UE (M-UE) may communicate with a base station via a UE being utilized as a relay between the MTC UE and the base station. An MTC device is generally capable of performing direct communication with another device. Thus, the M-UE and the UE may communicate with each other via D2D communication, for example. MTC devices are generally low-power devices and are generally optimized to achieve long battery life, low cost and complexity as well as high link budget. Therefore, improved battery life and improved link budget, while minimizing complexity of the MTC system, may be desirable.

In an aspect of the disclosure, an MTC device (e.g., M-UE) may connect with a D2D UE (D-UE) via D2D connection and the D-UE may connect with a base station, such that the MTC device may perform UL communication with the base station through the UE as a relay. In an aspect, the D2D UE may be a UE capable of D2D communication with the MTC device. The communication between the MTC device and the D-UE may be unidirectional. In an aspect, the MTC device may use the D-UE as a relay to communicate with the base station for UL communication, but may not use the D-UE as a relay for DL communication from the base station. For example, the MTC device may use a D-UE as a relay for UL communication to the base station, while the base station may perform DL communication directly with the MTC device without using a D-UE as a relay. The DL communication between the base station and the MTC device may include feedback for UL messages sent from the M-UE to the D-UE on a D2D communication link.

Performing a direct DL communication between the base station and the M-UE (without utilizing a relay) while utilizing a relay for a UL communication may reduce cost and complexity. In particular, if the M-UE receives a direct DL communication from the base station without relying on a relay UE, the M-UE does not need to implement a receiver to receive D2D communication from the relay UE. As such, there is no cost or complexity associated with implementing the receiver for the D2D communication in the M-UE. Utilizing a UE (e.g., a D-UE) as a relay for UL communication from the M-UE to the base station may improve battery life of the M-UE, due to lower transmission times and/or transmission power as well as due to reduction in inter-cell interference (ICI) in UL resources. In particular, the M-UE transmitting to the D-UE may experience lower transmission time and/or lower transmission power than the M-UE transmitting directly to the base station. Further, if the M-UE utilizes the D-UE as a relay for UL communication to the base station, the M-UE is not involved with a potentially long UL transmission directly to the base station, and thus a system involving the M-UE and the base station experiences less interference than when the M-UE transmits directly to the base station.

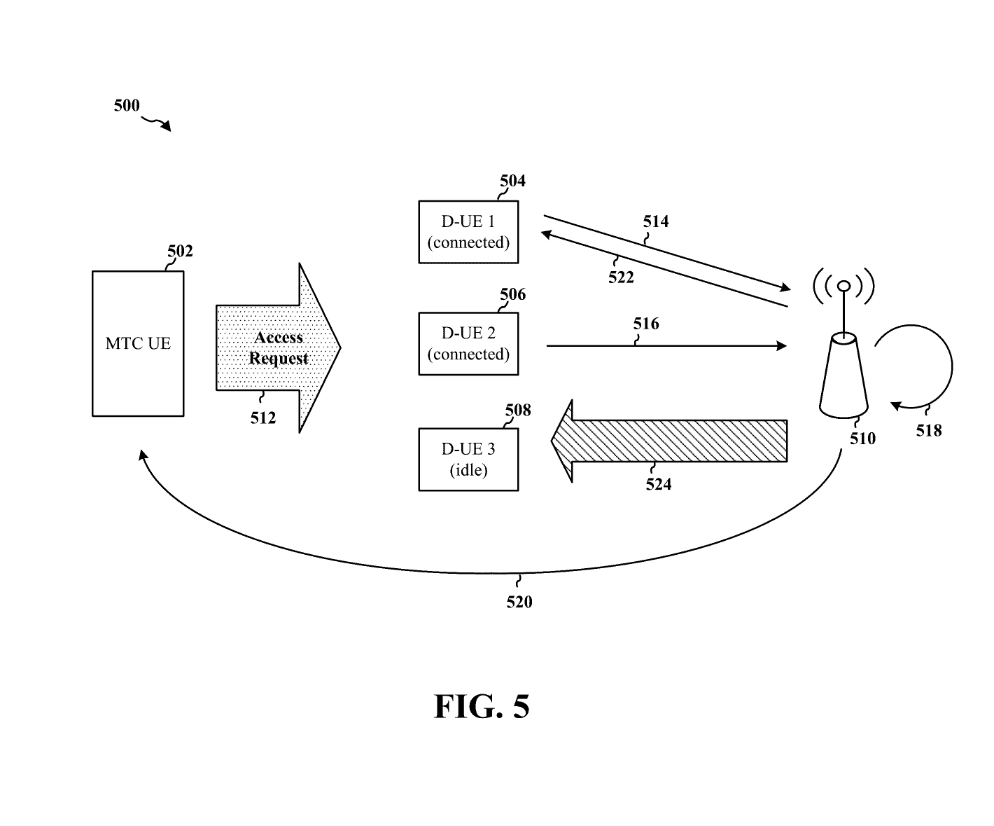

FIG. 5 is an example diagram 500 illustrating a connection setup procedure for a MTC device to utilize a relay for UL communication, according to an aspect of the disclosure. The example diagram 500 of FIG. 5 illustrates interactions between an M-UE 502, D-UEs 504, 506, and 508, and a base station (eNB 510). After triggering a random access procedure to communicate with the eNB 510, the M-UE 502 waits for the next discovery resource pool for resources for D2D communication. The discovery resource pool may be identified in a SIB message received from the eNB 510. During the discovery resource pool, at 512, the M-UE 502 transmits an access request message to the D-UEs (D-UE 1 904, D-UE 2 506, and D-UE 3 508) to request access to the eNB 510 through at least one of the D-UEs as a relay. The M-UE 502 may transmit the access request message in a discovery message. In an aspect, the M-UE 502 may transmit the discovery message including the access request via broadcast to the D-UEs.

The discovery message transmitted by the M-UE 502 may further include DL channel quality information such as a DL CQI. The eNB 510 may perform DL communication directly with the M-UE 502 using the DL CQI. In particular, the eNB 510 may use the DL CQI to select a modulation coding scheme (MCS), for link budgeting/provisioning for the DL communication with the M-UE 502. The discovery message may also include a cell identifier that identifies a cell (e.g., operated by the eNB 510) that the M-UE 502 is camped on or connected to, such that the access request from the M-UE 502 may be received by D-UEs that are connected to or camped on the cell corresponding to the cell identifier. If a D-UE receiving the access request is connected to or camped on a cell associated with a different cell identifier than the cell identifier included in the access request, then the D-UE may purge the access request and may not forward the access request. The discovery message may include a device identifier identifying the M-UE 502. The device identifier may include at least one of a random string value, a system architecture evolution temporary mobile subscriber identity (S-TMSI) or a cell radio network temporary identifier (C-RNTI) corresponding to the M-UE 502. The S-TMSI may be temporarily allocated to the M-UE 502 when the M-UE 502 connects to the network. The type of a device identifier included in the access request may depend on availability of the device identifier and/or a connection stage of the M-UE 502. For example, if the M-UE 502 has not been connected to the network and the neither an S-TMSI nor a C-RNTI is available, the M-UE 502 may utilize the random string value as the device identifier, at least until the S-TMSI and the C-RNTI are assigned. The discovery message may further include an RRC configuration request, and/or a buffer status report (BSR).

D-UEs (e.g., D-UE 1 504, D-UE 2 506, D-UE 3 508) receive a discovery message in the discovery resources, and thus may read the access request included in the discovery message. Some D-UEs may be idle D-UEs that do not have an ongoing connection with a base station, while other D-UEs may be RRC connected D-UEs (connected D-UEs) having ongoing connections with the base station (e.g., in connected mode). Because a connected D-UE has an ongoing connection with the base station, the connected UE is able to forward the discovery message shortly after receiving the discovery message from the M-UE, without much delay. Thus, at 514, the D-UE 1 504 that is in a connected state with the eNB 510 forwards the access request to the eNB 510 without much delay. Similarly, at 516, the D-UE 2 506 that is in a connected state with the eNB 510 forwards the access request to the eNB 510 without much delay. In an aspect, one or more D-UEs may not forward the access request immediately, but instead may buffer the access request, in order to forward the access request to the eNB at a later time. In such an aspect, by delaying forwarding of the access request by some D-UEs, not all D-UEs forward the access request to the eNB around the same time. Thus overcrowding of the eNB with many D-UEs forwarding the same access request around the same time may be avoided.

On the other hand, for an idle UE to forward the discovery message to the base station, the idle UE should enter an RRC connected state with the base station to become a connected UE which may take some time. Thus, the idle UE may take more time to forward the discovery message to the base station than for the connected UE because of time taken to enter a connected state with the base station before forwarding the discovery message by the idle UE. In the example diagram 500, even after the D-UE 1 504 and the D-UE 2 506 have forwarded the access request to the eNB 510, the D-UE 3 508 still has not entered the connected state with the eNB 510 and thus has not forwarded the access request to the eNB 510. It is noted that, if one or more connected UEs have already forwarded the access request to the eNB 510, the eNB 510 may prevent idle UEs from having to enter an RRC connected state to forward the same access request to the eNB. For example, after receiving the access request from one or more connected UEs, the eNB may send a purge access request message to the idle UEs such that the idle UEs may purge the access request from a buffer within the idle UEs. Thus, the idle UEs do not enter the RRC connected state to forward the access request. The purge access request message is described in more detail infra.

When a D-UE (e.g., D-UE 1 504 at 514 or D-UE 2 506 at 516) forwards the access request to the eNB 510, the D-UE forwards the access request along with D2D signal information such as Reference Signal Received Power (RSRP) and/or Reference Signal Received Quality (RSRQ) of the D2D connection between the M-UE and the D-UE. The D-UE may measure the D2D signal information using the discovery message containing the access request from the M-UE, as the discovery message is transmitted to the D-UE via D2D communication. After the eNB 510 receives the access request and the D2D signal information from each of the D-UEs (e.g., D-UE 1 504 and D-UE 2 506), the eNB 510 selects a D-UE among the D-UEs that forwarded the access request, where the selected D-UE is to perform as a relay. In particular, the eNB 510 receives at 514, from the D-UE 1 504, an access request with D2D signal information for the M-UE 502 and the D-UE 1 504, and receives at 516, from D-UE 2 506, an access request with D2D signal information for the M-UE 502 and the D-UE 2 506. Then, the eNB 510 selects at 518 one of the D-UE 1 504 and the D-UE 2 506 as a relay. In the example diagram 500, the eNB 510 selects D-UE 1 504 as a relay at 518. The eNB 510 may select a D-UE as a relay based on the D2D signal information. In particular, the eNB 510 may select a D-UE with the best D2D signal information (e.g., highest RSRP and/or RSRQ) among the D-UEs that have forwarded the access request and the D2D signal information to the eNB 510. For example, if the eNB 510 determines that the D-UE 1 504 has a higher RSRP and/or RSRQ of the D2D connection with the M-UE 502 than the RSRP and/or RSRP of the D2D connection between the D-UE 2 506 and the M-UE 502, the eNB 510 selects the D-UE 1 504 as a relay. In addition (or as an alternative) to considering the D2D signal information, the eNB 510 may additionally consider a distance between a D-UE and the eNB as well as signal strength of communication between the D-UE and the eNB for selection of a D-UE as a relay. For example, the eNB 510 may select a D-UE with the best condition for relay communication (e.g., the best D2D signal information, the closest distance to the eNB 510, and the highest signal strength for communication with the eNB 510). An algorithm to consider the D2D signal information, the distance to the eNB 510, and the signal strength for communication with the eNB 510 may be implemented in the eNB 510. Therefore, at 518, the eNB 510 may select D-UE 1 504 because the eNB 510 determines that D-UE 504 provides the best condition for relay communication. In an aspect, the distance between the D-UE and the eNB may be determined based on location information such as a global positioning system (GPS) information of the D-UE and/or the eNB.

In one aspect, if the eNB 510 selects at least one D-UE as a relay, the eNB 510 sends an access response request (ARR) message including a D2D connection identifier (D2D C-ID) to the M-UE 502, where the D2D C-ID identifies the at least one D-UE that is selected as a relay. In an aspect, if the eNB 510 selects multiple D-UEs as relays, the eNB 510 sends an ARR including a D2D C-ID to the M-UE 502, where the D2D C-ID indicates the multiple D-UEs that are selected as relays. The D2D C-ID may be a layer-2 ID (L2 ID) to be used by the M-UE 502 for D2D communication with the D-UE that is selected as a relay. The ARR message may further include a C-RNTI (physical layer identifier for random access) of the M-UE 502. In the example diagram 500, at 520, the eNB 510 sends an ARR message including a D2D C-ID to the M-UE 502, where the D2D C-ID identifies that D-UE 1 504 is selected as a relay. The ARR message may be similar to a random access response (RAR). The eNB may address the ARR message to a random access RNTI (RA-RNTI), or to a new access request RNTI (AR-RNTI), or may address the ARR message to a C-RNTI if the M-UE has a C-RNTI. The eNB 510 may send the ARR message during one or more time windows that are known to the M-UE 502, such that the search duration for the M-UE 502 to search for the ARR message may be limited to the one or more time windows. Such time windows may also be associated with a device identifier of the M-UE 502 such that the M-UE 502 may be able to determine the search duration by reading the device identifier included in the ARR.

In another aspect, the eNB 510 may not select any of the D-UEs that have forwarded the access request to the eNB 510. In such an aspect, if the eNB 510 does not select any D-UE as a relay, the ARR message may include an indication that no D-UE has been selected as a relay. For example, the eNB 510 may not select any D-UE because the eNB 510 determines that none of the D-UEs that have forwarded the access request may be suitable as a relay. The eNB 510 may make such determination based on the D2D signal information and/or the D-UE's distance to the eNB and/or the D-UE's signal strength with the eNB. For example, the eNB 510 may determine that a D-UE is suitable as a relay if the D2D signal information corresponding to the D-UE is above a minimum threshold. The indication that no D-UE has been selected as a relay may be an explicit indication or an implicit indication. For the implicit indication, the ARR message including a reserved C-ID may implicitly indicate that no D-UE has been selected. In some cases, the ARR message may further include an access bar command that indicates that the M-UE 502 should not try discovering the network or accessing the network. For example, the eNB 510 may include the access bar command in the ARR message if the network is too congested to provide communication with the M-UE 502, and/or the M-UE 502 is barred from communicating with the eNB 510. In an aspect, if the ARR message includes the indication that no D-UE has been selected as a relay, the ARR message may not include a D2D C-ID because no D-UE is selected as a relay.

If the eNB 510 selects a D-UE as a relay, the eNB 510 further sends the D2D C-ID to the D-UE that is selected as a relay. In an aspect, if the eNB 510 selects multiple D-UEs as relays, the eNB 510 sends a D2D C-ID to the selected multiple D-UEs, where the D2D C-ID indicates the multiple D-UEs that are selected as relays. The selected D-UEs that have received the D2D C-ID listen for the D2D C-ID from the M-UE 502, such that the D-UEs may communicate with the M-UE 502 based on the D2D C-ID. The D2D C-ID may be a D2D layer-2 ID that the D-UE may use to receive and/or identify D2D communication from the M-UE 502. After selecting a D-UE as a relay, the eNB 510 may further send an RRC reconfiguration message to the selected D-UE, where the RRC reconfiguration message configures the selected D-UE to relay the messages from M-UE and/or configures a connection state of the D2D link between the M-UE and the selected D-UE. For example, the RRC reconfiguration message may associate a logical channel at the selected D-UE with the data from the M-UE that is being relayed, such that the data from the M-UE may be forwarded to the eNB under the logical channel. Thus, in the example diagram 500, at 522, the eNB 510 sends the D2D C-ID to D-UE 1 504, where the D2D C-ID identifies that D-UE 1 504 is selected as a relay. At 522, the eNB 510 may further send the RRC reconfiguration message to D-UE 1 504. After the eNB 510 sends the ARR message to the M-UE 502 and sends the D2D C-ID to the selected D-UE (D-UE 1 504), both the selected D-UE (D-UE 1 504) and the M-UE 502 have the D2D C-ID, which is used to for communication between the selected D-UE (D-UE 1 504) and the M-UE 502.

In an aspect, after selecting a D-UE as a relay, the eNB 510 may send a purge access request (PAR) message to D-UEs that still have a pending access request that has not been forwarded to the eNB, where the PAR message indicates to such D-UEs that the pending access request should be purged. Upon receiving the PAR message, the D-UEs having the pending access request purge the access request, without forwarding the pending access request to the eNB 510. The eNB 510 may address the PAR message to a new RNTI such as a PAR RNTI. The D-UEs may each maintain the access requests in a buffer before forwarding the access requests. The eNB 510 may send the PAR message via broadcast to the D-UEs with the pending access requests. In the example diagram 500, at 524, the eNB 510 sends a PAR message to the D-UE 3 508 that has not yet forwarded the access request to the eNB 510. Upon receiving the PAR message, the D-UE 3 508 purges the pending access request from a buffer within the D-UE3 508, and thus does not forward the pending access request to the eNB. The PAR message may also prevent the D-UE 3 508 from entering a connected state with the eNB 510. The PAR message may identify one or more access requests to be purged, and the D-UE receiving the PAR message may purge the access requests that are identified in the PAR message. It is noted that after the eNB 510 selects a D-UE as a relay, the eNB 510 may not need to receive an access request from another D-UE having a pending access request, and thus purging the pending access request may be preferable. The PAR message may include one or more device identifiers (e.g., random string values, an S-TMSI, a C-RNTI of the M-UE 502 that are used to identify access requests to be purged.

The eNB (e.g., eNB 510) may implement a rule for determining whether to send a PAR message. In one aspect, the eNB may determine to send a PAR message only if the eNB determines that the D2D signal information for the selected D-UE and/or the signal strength between the selected D-UE and the eNB are above minimum thresholds. If the D2D signal information for the selected D-UE and/or the signal strength between the selected D-UE and the eNB are below minimum thresholds, the eNB may not send the PAR message and may continue to receive the access request along with D2D signal information forwarded from other D-UEs, and may attempt to select a D-UE with better D2D signal information and/or better signal strength with the eNB. In another aspect, the eNB may send a PAR message to D-UEs that still have not forwarded the access request if the eNB determines to reject the access request. In such an aspect, when a D-UE forwards an access request to the eNB, the eNB may determine to reject the access request, and may subsequently send a PAR message to other D-UEs to purge the same access request. Thus, by using the PAR message, unnecessary transmission or maintenance of the access request may be prevented, thereby conserving resources and preventing overcrowding of the eNB with unnecessary forwarding of the access request(s) to the eNB. In another aspect, if the eNB has received the access request from one or more D-UEs, the eNB may send the PAR message to other D-UEs that have not forwarded the access request to the eNB.

D-UEs that have pending access requests may monitor for the PAR messages from the eNB. Further, the transmission times of the PAR messages are predefined, and the eNB sends the PAR messages during the predefined transmission times. Thus, the D-UEs with pending access requests may monitor for the PAR messages during certain time windows, based on the predefined transmission times for the PAR messages. For example, if it takes approximately 80 milliseconds (msec) for all connected D-UEs to forward the access request to the eNB and the eNB may attempt to receive the access request forwarded by approximately a half of the connected D-UEs, the eNB may set the transmission time of the PAR messages to 40 msec, such that the eNB may send the PAR message to D-UEs with pending access requests at 40 msec after the M-UE transmits the access request. In another example, if it takes approximately 100 msec for idle D-UEs to enter a connected state to forward the access request, and the eNB attempts to receive the access request forwarded by at least one of the idle D-UEs, the eNB may set the transmission time of the PAR messages to 100 msec.

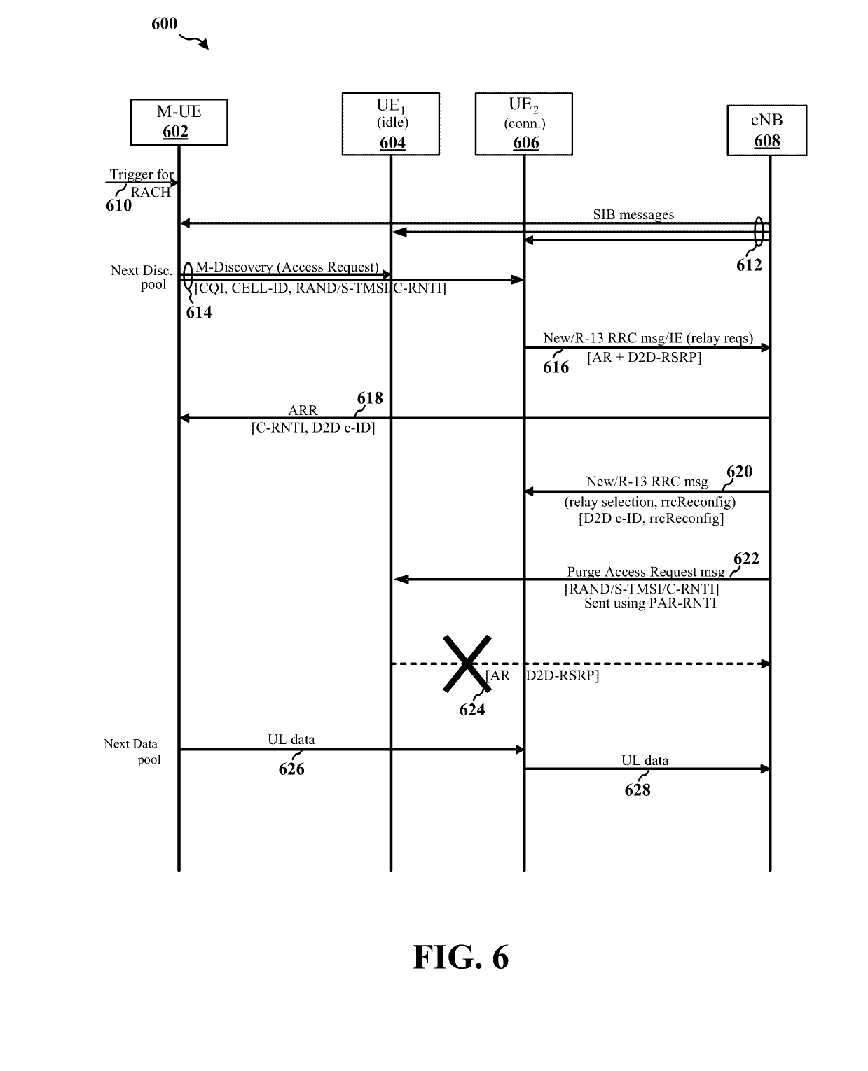

FIG. 6 is an example flow diagram 600 illustrating a connection setup to utilize a relay for UL communication, according to an aspect of the disclosure. The example flow diagram 600 of FIG. 6 illustrates interactions between an M-UE 602, a D-UE 1 604, a D-UE 2 606, and a base station (eNB 608). According to the disclosure, a D2D discovery procedure may be utilized to set up a relay connection between the M-UE 602 and the eNB 608. At 610, the M-UE 602 receives a trigger for a random access procedure to establish a random access channel (RACH) for communication with the eNB 608. At 612, the eNB 608 may broadcast one or more SIB messages, where the SIB message includes a resource pool configuration for D2D Discovery. The SIB message identifies D2D Discovery resource pools that indicate locations where a D2D discovery message may be transmitted. The M-UE 602 may receive the SIB messages broadcast by the eNB 608, and decodes the SIB messages. Each of the D-UEs (the D-UE 1 604 and the D-UE 2 606) may receive the SIB messages broadcast by the eNB 608, and may start monitoring some or all of the D2D discovery resource pools indicated in the SIB message.

At 614, during a time window corresponding to the next available D2D discovery resource pool, the M-UE 602 broadcasts an access request in a discovery message (e.g., M-Discovery message) transmitted using a D2D discovery resource pool to the D-UEs (e.g., the D-UE 1 604 and the D-UE 2 606). The access request may include an estimate of DL channel quality such as a CQI. The access request may include device identifier of the M-UE 602 such as a random bit string, M-UE's C-RNTI, or M-UE's S-TMSI. The access request may include a cell identifier (Cell-ID) of a cell that the M-UE 602 is camped on or connected to. The discovery message may further include an RRC configuration request, and a BSR.

At 616, the D-UE 2 606 decodes a discovery message including the access request received from the M-UE 602, and may forward the access request to the eNB 606 along with D2D signal information (e.g., RSRP and/or RSRQ) of the D2D connection between the M-UE 602 and the D-UE 2 606. The D-UE 2 606 is an RRC connected UE, and thus is capable of forwarding the access request to the eNB 606 shortly after receiving the access request, without much delay. The D-UE 2 606 may measure D2D signal information using the discovery message from the M-UE 602. The D-UE 2 606 may forward the access request to the eNB 606 in an RRC message. After receiving the forwarded access request with the D2D signal information from D-UEs, the eNB 608 may select one or more of D-UEs to act as relays for communication between the M-UE 602 and the eNB 608. The eNB 608 may select one or more of D-UEs to act as relays based on the D2D signal information received from the D-UEs.

In the example flow diagram 600, the eNB 608 selects the D-UE 2 606 as a relay. Thus, at 618, the eNB 608 sends an ARR message to the M-UE 602. The ARR message may include a D2D C-ID identifying the D-UE 2 606 that is selected as a relay. The ARR message may further include a C-RNTI of the M-UE 602. At 620, the eNB 608 sends, to the D-UE 2 606, the D2D C-ID identifying the D-UE 2 606 that is selected as a relay, and an RRC reconfiguration message.

At 622, the eNB 608 sends a PAR message to the D-UE 1 604 that has not forwarded the access request from the M-UE 602, where the PAR message indicates to the D-UE 1 604 that the pending access request within the D-UE 1 604 should be purged. The PAR message may include the device identifier of the M-UE 602, such as the random bit string, M-UE's C-RNTI, or M-UE's S-TMSI. The eNB 608 may send the PAR message using a PAR-RNTI. The D-UE 1 604 is an idle UE, and thus may need to enter an RRC connected state to be able to forward the access request to the eNB 606. Hence, the D-UE 1 604 may experience a delay in forwarding of the access request for a longer duration than that of connected UEs. In the example flow diagram 600, the D-UE 1 604 has not entered a connected state to forward the access request to the eNB 606 when the D-UE 1 604 receives the PAR message from the eNB 608 at 622. At 624, because the D-UE 1 604 received the PAR message and purged the access request, the D-UE 1 604 does not forward the access request to then eNB 608.

After 618 and 620, the M-UE 602 and the D-UE 2 606 both have the same D2D C-ID, and the M-UE 602 may start utilizing, based on the D2D C-ID, the D-UE 2 606 as a relay for UL communication to the eNB 608. For example, at 626, during the next data resource pool, the M-UE 602 may initiate UL communication for the eNB 608 by transmitting UL data to the D-UE 2 606, and at 628, the D-UE 2 606 relays the UL data to the eNB 608.

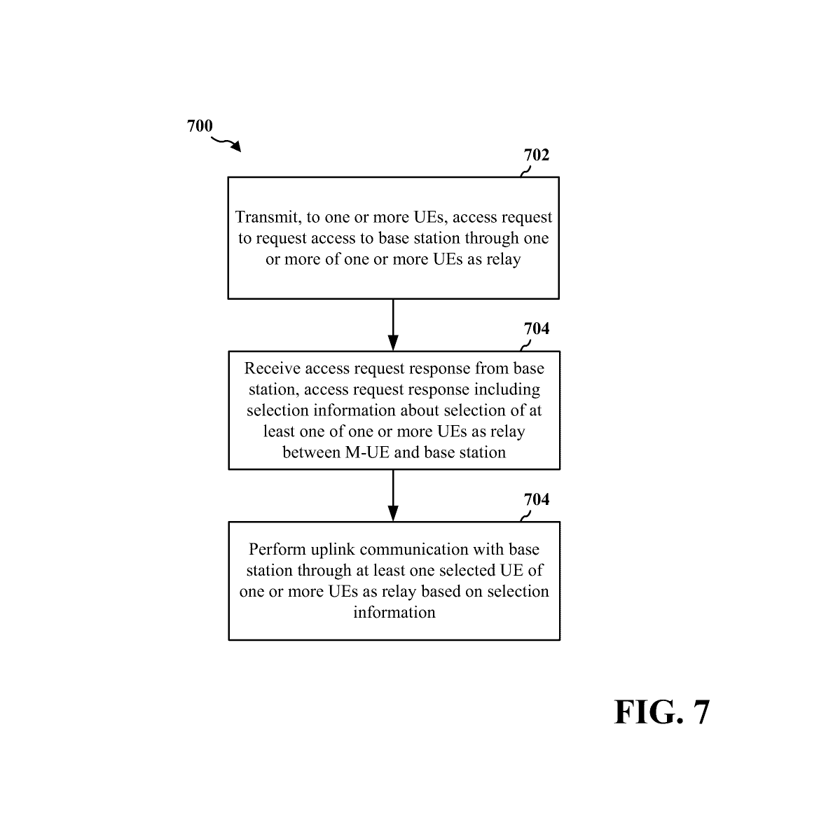

FIG. 7 is a flowchart 700 of a method of wireless communication. The method may be performed by an M-UE (e.g., the M-UE 502, the apparatus 802/802′).

At 702, the M-UE transmits, to one or more UEs, an access request to request access to a base station through one or more of the one or more UEs as a relay. In an aspect, the access request is transmitted by transmitting a discovery message including the access request to the one or more UEs as a relay. In such an aspect, the discovery message is transmitted during a discovery resource pool, the discovery resource pool being identified in a SIB message received from the base station. For example, as discussed supra, during the discovery resource pool, at 512, the M-UE 502 transmits an access request message to the D-UEs (D-UE 1 504, D-UE 2 506, and D-UE 3 508), where the M-UE 502 may transmit the access request message in a discovery message. For example, as discussed supra, the discovery resource pool may be identified in a SIB message received from the eNB 510.

In such an aspect, the discovery message includes at least one of DL channel quality information, a device identifier of the M-UE, a cell identifier of a cell that the M-UE is camped on or connected to, an RRC configuration request, or a BSR. In such an aspect, the device identifier includes at least one of a random bit string, an S-TMSI or a C-RNT) of the M-UE. For example, as discussed supra, the discovery message transmitted by the M-UE 502 may include at least one of DL channel quality information such as a DL CQI, a cell identifier that identifies a cell (e.g., operated by the eNB 510) that the M-UE 502 is camped on or connected to, a device identifier identifying the M-UE 502, an RRC configuration request, or a BSR. For example, as discussed supra, the device identifier may include at least one of a random string value, an S-TMSI or a C-RNTI corresponding to the M-UE 502.

At 704, the M-UE receives an access request response from the base station, the access request response including selection information about selection of at least one of the one or more UEs as a relay between the M-UE and the base station. In an aspect, the selection information includes at least one of a connection identifier, the connection identifier being used for communication between the M-UE and at least one selected UE of the one or more UEs, or an indication that no UE is selected as a relay. For example, as discussed supra, if the eNB 510 selects a D-UE as a relay, the eNB 510 sends an ARR message including a D2D C-ID to the M-UE 502, where the D2D C-ID identifies a D-UE that is selected as a relay. For example, as discussed supra, if the eNB 510 does not select any D-UE as a relay, the ARR message may include an indication that no D-UE has been selected as a relay. For example, as discussed supra, in some cases, the ARR message may further include an access bar command that indicates that the M-UE should not try discovering a network or accessing the network. For example, as discussed supra, the ARR message may further include a C-RNTI (physical layer identifier for random access) of the M-UE 502.

At 706, the M-UE may perform uplink communication with the base station through at least one selected UE of the one or more UEs as a relay based on the selection information. For example, as discussed supra, after the eNB 510 sends the ARR message to the M-UE 502 and sends the D2D C-ID to the selected D-UE (D-UE 1 504), both the selected D-UE (D-UE 1 504) and the M-UE 502 have the D2D C-ID, which is used to for communication between the selected D-UE (D-UE 1 504) and the M-UE 502.

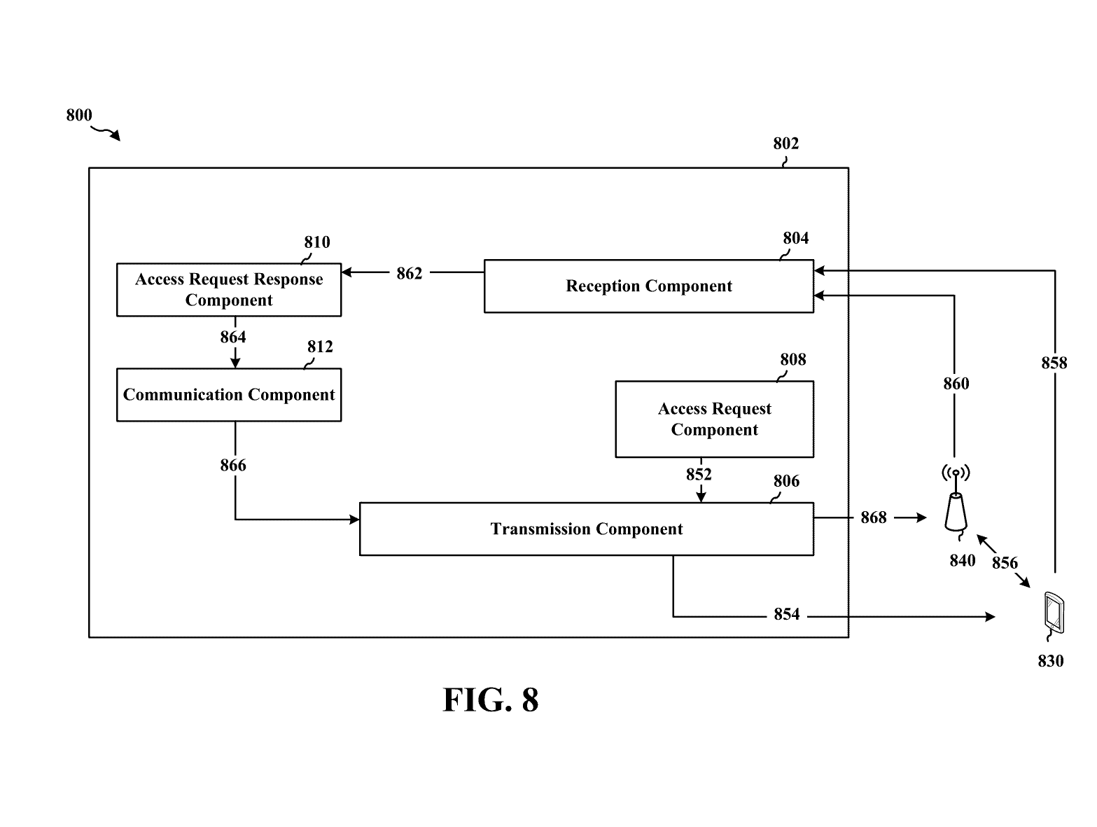

FIG. 8 is a conceptual data flow diagram 800 illustrating the data flow between different means/components in an exemplary apparatus 802. The apparatus may be an M-UE. The apparatus includes a reception component 804, a transmission component 806, an access request component 808, an access request response component 810, and a communication component 812.

The access request component 808 transmits via the transmission component 806, to one or more UEs (e.g., the UE 830), an access request to request access to a base station 840 through one or more of the one or more UEs as a relay, at 852 and 854. In an aspect, the access request is transmitted by transmitting a discovery message including the access request to the one or more UEs requested to act as a relay. In such an aspect, the discovery message is transmitted during a discovery resource pool, the discovery resource pool being identified in a SIB message received from the base station. In an aspect, the UE 830 and the base station 840 may communicate with each other at 856. In an aspect, the UE 830 may communicate to the M-UE 802 via the reception component 804, at 858.

In such an aspect, the discovery message includes at least one of DL channel quality information, a device identifier of the M-UE, a cell identifier of a cell that the M-UE is camped on or connected to, an RRC configuration request, or a BSR. In such an aspect, the device identifier includes at least one of a random bit string, an S-TMSI or a C-RNT of the M-UE.

The access request response component 810 receives, via the reception component 804, an access request response from the base station 840, the access request response including selection information about selection of at least one of the one or more UEs as a relay between the M-UE and the base station 840, at 860 and 862. In an aspect, the selection information includes at least one of a connection identifier, the connection identifier being used for communication between the M-UE and at least one selected UE of the one or more UEs, or an indication that no UE is selected as a relay. The access request response component 810 may forward the selection information to the communication component 812, at 864.

The communication component 812 may perform via the transmission component 806 uplink communication with the base station 840 through at least one selected UE of the one or more UEs as a relay based on the selection information, at 866, 854, and 856. In some aspects, the transmission component 806 may be configured to communicate to the base station 840, at 868.

The apparatus may include additional components that perform each of the blocks of the algorithm in the aforementioned flowcharts of FIG. 7 As such, each block in the aforementioned flowcharts of FIG. 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

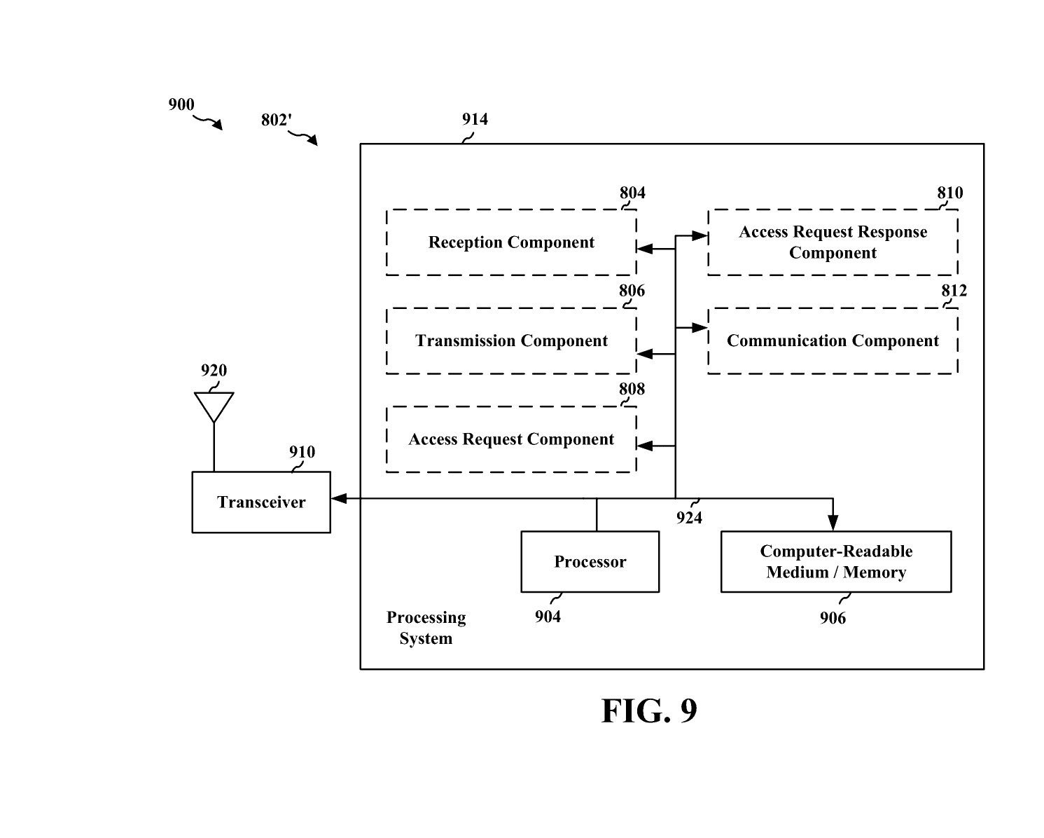

FIG. 9 is a diagram 900 illustrating an example of a hardware implementation for an apparatus 802′ employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware components, represented by the processor 904, the components 804, 806, 808, 810, 812, and the computer-readable medium/memory 906. The bus 924 may also link various other circuits such as timing sources, peripherals, voltage regulators, and power management circuits, which are well known in the art, and therefore, will not be described any further.

The processing system 914 may be coupled to a transceiver 910. The transceiver 910 is coupled to one or more antennas 920. The transceiver 910 provides a means for communicating with various other apparatus over a transmission medium. The transceiver 910 receives a signal from the one or more antennas 920, extracts information from the received signal, and provides the extracted information to the processing system 914, specifically the reception component 804. In addition, the transceiver 910 receives information from the processing system 914, specifically the transmission component 806, and based on the received information, generates a signal to be applied to the one or more antennas 920. The processing system 914 includes a processor 904 coupled to a computer-readable medium/memory 906. The processor 904 is responsible for general processing, including the execution of software stored on the computer-readable medium/memory 906. The software, when executed by the processor 904, causes the processing system 914 to perform the various functions described supra for any particular apparatus. The computer-readable medium/memory 906 may also be used for storing data that is manipulated by the processor 904 when executing software. The processing system 914 further includes at least one of the components 804, 806, 808, 810, 812. The components may be software components running in the processor 904, resident/stored in the computer readable medium/memory 906, one or more hardware components coupled to the processor 904, or some combination thereof.

In one configuration, the apparatus 802/802′ for wireless communication includes means for transmitting, to one or more UEs, an access request to request access to a base station through one or more of the one or more UEs as a relay, means for receiving an access request response from the base station, the access request response including selection information about selection of at least one of the one or more UEs as a relay between the apparatus 802/802′ and the base station, and means for performing uplink communication with the base station through at least one selected UE of the one or more UEs as a relay based on the selection information. The aforementioned means may be one or more of the aforementioned components of the apparatus 802 and/or the processing system 914 of the apparatus 802′ configured to perform the functions recited by the aforementioned means.

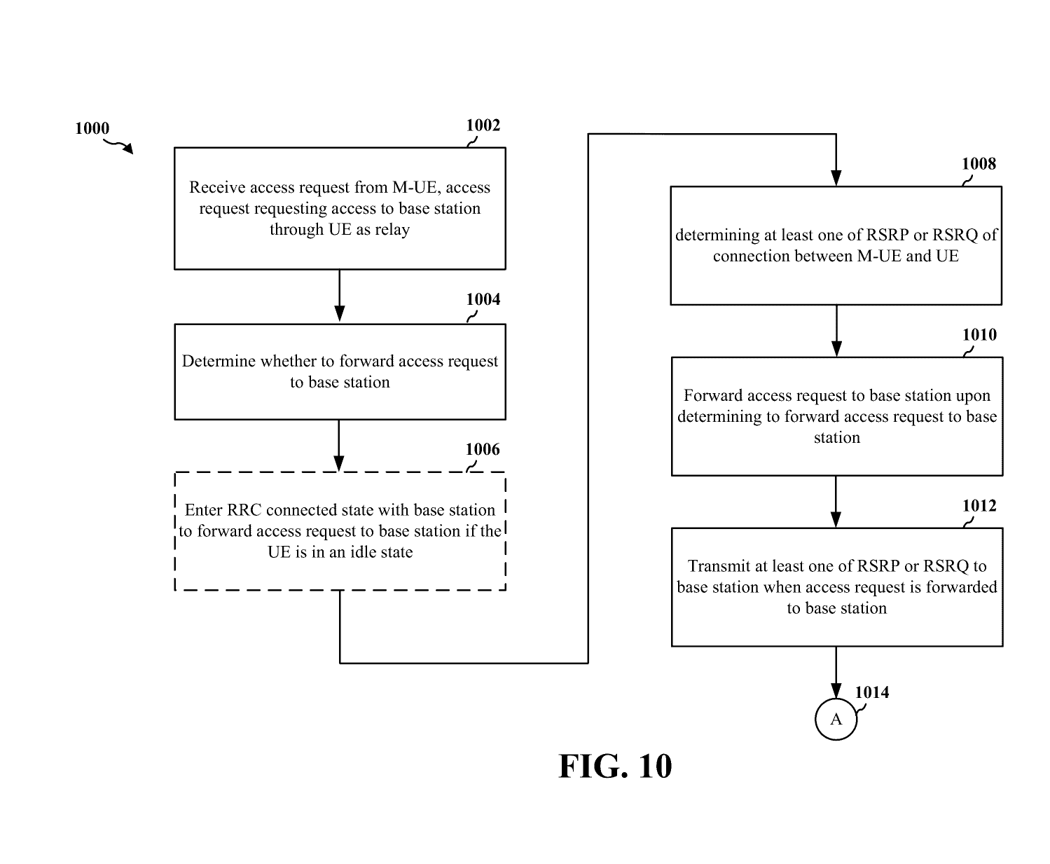

FIG. 10 is a flowchart 1000 of a method of wireless communication. The method may be performed by a UE (e.g., one of the D-UEs 504, 506, 508, the apparatus 1202/1202′). At 1002, the UE receives an access request from an M-UE, the access request requesting access to a base station through the UE as a relay. For example, as discussed supra, at 512, the M-UE 502 transmits an access request message to the D-UEs (D-UE 1 504, D-UE 2 506, and D-UE 3 508) to request access to the eNB 510 through at least one of the D-UE as a relay. In an aspect, the access request is received in a discovery message from the M-UE. For example, as discussed supra, the M-UE 502 may transmit the access request message in a discovery message. For example, as discussed supra, D-UEs (e.g., D-UE 1 504, D-UE 2 506, D-UE 3 508) listen to a discovery message in the discovery resources, and thus may read the access request included in the discovery message.

In such an aspect, the discovery message includes at least one of DL channel quality information, a device identifier of the M-UE, a cell identifier of a cell that the M-UE is camped on or connected to, an RRC configuration request, or a BSR. In such an aspect, the device identifier includes at least one of a random bit string, an S-TMSI or a C-RNT) of the M-UE. For example, as discussed supra, the discovery message transmitted by the M-UE 502 may include at least one of DL channel quality information such as a DL CQI, a cell identifier that identifies a cell (e.g., operated by the eNB 510) that the M-UE 502 is camped on or connected to, a device identifier identifying the M-UE 502, an RRC configuration request, or a BSR. For example, as discussed supra, the device identifier may include at least one of a random string value, an S-TMSI or a C-RNTI corresponding to the M-UE 502.

At 1004, the UE determines whether to forward the access request to the base station. In an aspect, the access request is forwarded to the base station when the UE is in an RRC connected state with the base station. At 1006, the UE may enter the RRC connected state with the base station to forward the access request to the base station when the UE is in an idle state. For example, as discussed supra, because the connected D-UEs have ongoing connection with the base station, the connected UE is able to forward the discovery message shortly after receiving the discovery message from the M-UE, without much delay. For example, as discussed supra, for an idle UE to forward the discovery message to the base station, the idle UE should enter an RRC connected state with the base station to become a connected UE.

At 1008, the UE determines at least one of a RSRP or a RSRQ of a connection between the M-UE and the UE. For example, as discussed supra, the D-UE may measure the D2D signal information such as RSRP and/or RSRQ of the D2D connection between the M-UE and the D-UE.

At 1010, the UE forwards the access request to the base station upon determining to forward the access request to the base station. For example, as discussed supra, because the connected D-UEs have ongoing connection with the base station, the connected UE is able to forward the discovery message shortly after receiving the discovery message from the M-UE.

At 1012, the UE transmits information indicating at least one of the RSRP or the RSRQ to the base station when the access request is forwarded to the base station. For example, as discussed supra, when a D-UE (e.g., D-UE 1 504 at 514 or D-UE 2 506 at 516) forwards the access request to the eNB 510, the D-UE forwards the access request along with D2D signal information such as RSRP and/or RSRQ of the D2D connection between the M-UE and the D-UE.

At 1014, the UE may perform additional features as described infra.

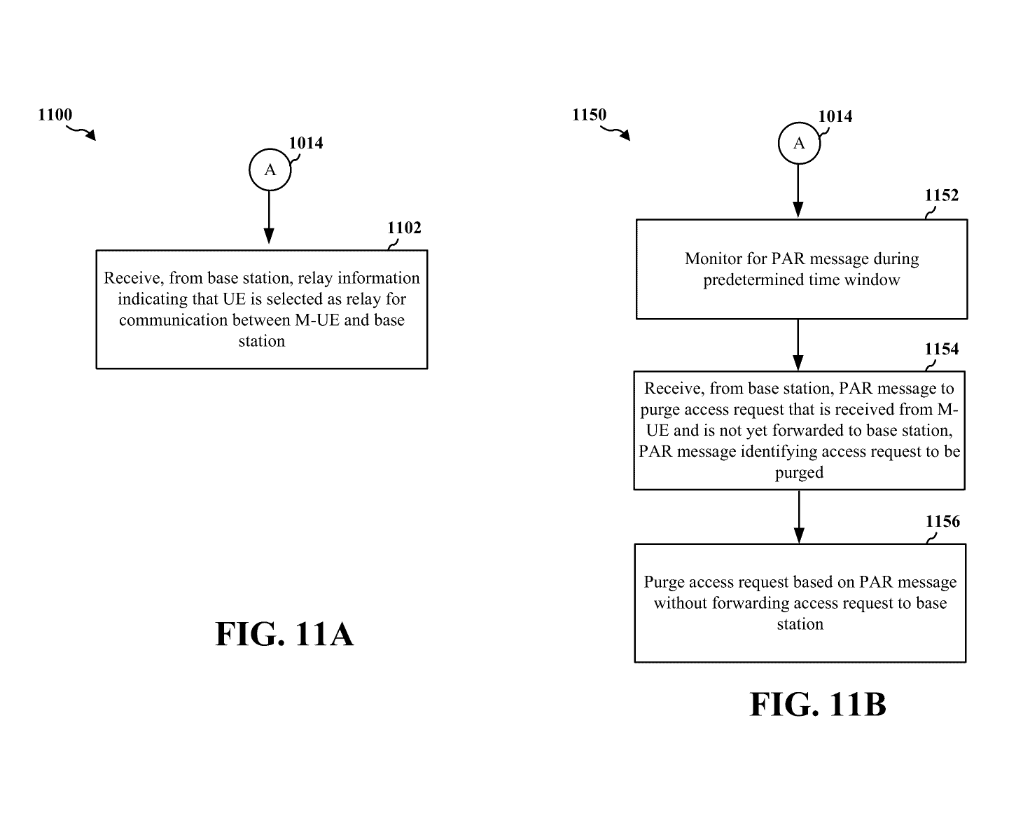

FIG. 11A is a flowchart 1100 of a method of wireless communication, expanding from the flowchart 1000 of FIG. 10, according to an aspect of the disclosure. The method may be performed by a UE (e.g., one of the D-UEs 504, 506, 508, the apparatus 1202/1202′). At 1014, the method continues from the flowchart 1000 of FIG. 10. At 1102, the UE receives, from the base station, relay information indicating that the UE is selected as the relay for communication between the M-UE and the base station. In an aspect, the relay information includes a connection identifier that is used for receiving communication from the M-UE. For example, as discussed supra, if the eNB 510 selects a D-UE as a relay, the eNB 510 further sends the D2D C-ID to the D-UE that is selected as a relay.

In an aspect, the relay information includes an RRC reconfiguration message used for configuration of the UE to relay communication from the M-UE or for configuration of a connection state of a communication link between the UE and the M-UE. In such an aspect, the RRC reconfiguration message associates a logical channel at the UE with data from the M-UE that is being relayed to the base station. For example, as discussed supra, after selecting a D-UE as a relay, the eNB 510 may further send an RRC reconfiguration message to the selected D-UE, where the RRC reconfiguration message configures the selected D-UE to relay the messages from M-UE and/or configures a connection state of the D2D link between the M-UE and the selected D-UE. For example, as discussed supra, the RRC reconfiguration message may associate a logical channel at the selected D-UE with the data from the M-UE that is being relayed, such that the data from the M-UE may be forwarded to the eNB under the logical channel.

FIG. 11B is a flowchart 1150 of a method of wireless communication, expanding from the flowchart 1000 of FIG. 10, according to an aspect of the disclosure. The method may be performed by a UE (e.g., one of the D-UEs 504, 506, 508, the apparatus 1102/1102′). At 1014, the method continues from the flowchart 1000 of FIG. 10. At 1152, the UE monitors for a PAR message during a predetermined time window. For example, as discussed supra, D-UEs that have pending access requests may monitor for the PAR messages from the eNB. For example, as discussed supra, the D-UEs with pending access requests may monitor for the PAR messages during certain time windows, based on the predefined transmission times for the PAR messages.

At 1154, the UE receives, from the base station, a PAR message to purge the access request that is received from the M-UE and is not yet forwarded to the base station, the PAR message identifying the access request to be purged. At 1156, the UE purges the access request based on the PAR message without forwarding the access request to the base station. For example, as discussed supra, the eNB 510 sends a PAR message to D-UEs that still have a pending access request that has not been forwarded to the eNB, where the PAR message indicates to such D-UEs that the pending access request should be purged. For example, as discussed supra, upon receiving the PAR message, the D-UEs having the pending access request purge the access request, without forwarding the pending request to the eNB 510.

In an aspect, the PAR message includes a device identifier of the M-UE to identify the access request to be purged. In such an aspect, the device identifier includes at least one of a random bit string, an S-TMSI or a C-RNTI of the M-UE. For example, as discussed supra, the PAR message may include one or more device identifiers (e.g., random string values, S-TMSI, C-RNTI) of the M-UE 502 that are used to identify access requests to be purged.

In an aspect, the PAR message is addressed to a PAR-RNTI. For example, as discussed supra, the eNB 510 may address the PAR message to a new RNTI such as a PAR RNTI.

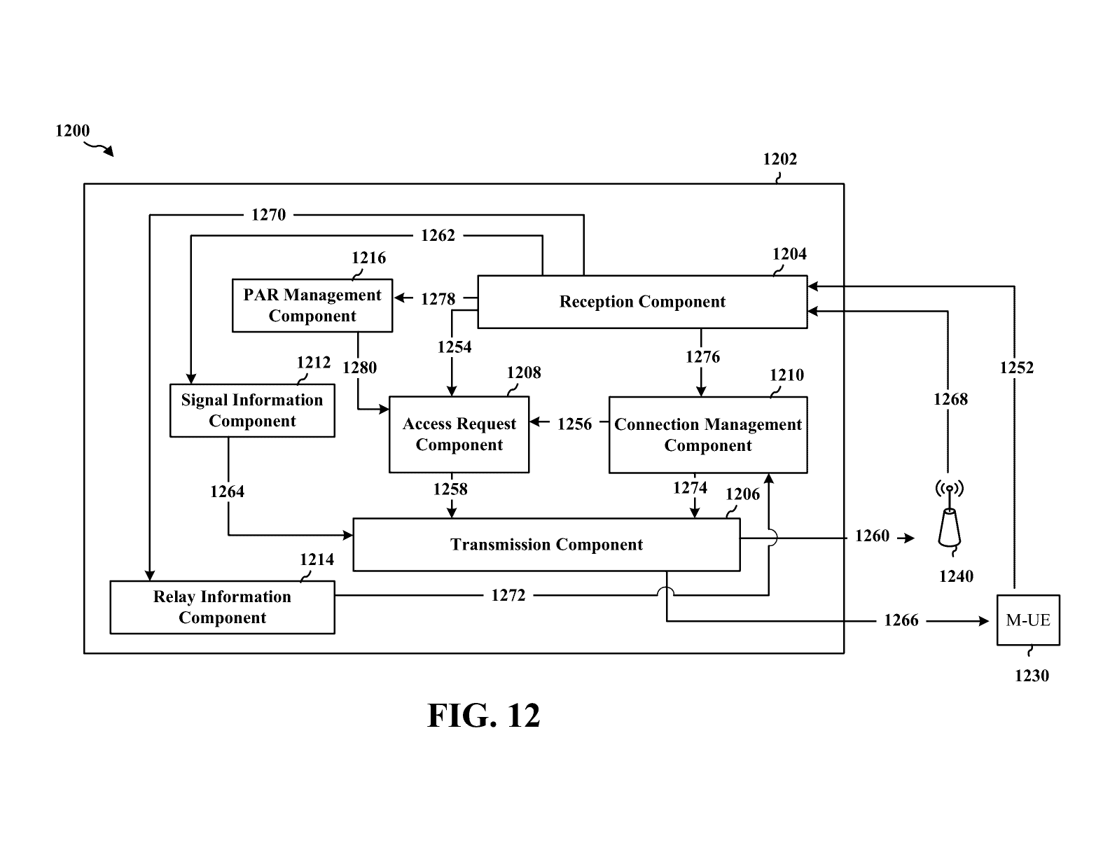

FIG. 12 is a conceptual data flow diagram 1200 illustrating the data flow between different means/components in an exemplary apparatus 1202. The apparatus may be a UE. The apparatus includes a reception component 1204, a transmission component 1206, an access request component 1208, an connection management component 1210, a signal information component 1212, a relay information component 1214, and a PAR management component 1216.

The access request component 1208 receives via the reception component 1204 an access request from a M-UE 1230, the access request requesting access to a base station 1240 through the UE as a relay, at 1252 and 1254. In an aspect, the access request is received in a discovery message from the M-UE 1230. In such an aspect, the discovery message includes at least one of DL channel quality information, a device identifier of the M-UE 1230, a cell identifier of a cell that the M-UE 1230 is camped on or connected to, an RRC configuration request, or a BSR. In such an aspect, the device identifier includes at least one of a random bit string, an S-TMSI or a C-RNT) of the M-UE 1230.

The access request component 1208 determines whether to forward the access request to the base station 1240. In an aspect, the access request is forwarded to the base station 1240 when the UE is in an RRC connected state with the base station 1240. The connection management component 1210 may cause the UE 1202 to enter the RRC connected state with the base station 1240 to forward the access request to the base station 1240 when the UE is in an idle state, and may forward related information to the access request component 1208, at 1256. The access request component 1208 forwards, via the transmission component 1206, the access request to the base station 1240 upon determining to forward the access request to the base station 1240, at 1258 and 1260.

A signal information component 1212 determines at least one of a RSRP or a RSRQ of a connection between the M-UE 1230 and the UE 1202, via the reception component 1204 and the transmission component 1262, for example, at 1252, 1262, 1264, and 1266. The signal information component 1212 transmits, via the transmission component 1206, information indicating at least one of the RSRP or the RSRQ to the base station 1240 when the access request is forwarded to the base station 1240, at 1264 and 1260.

A relay information component 1214 receives via the reception component 1204, from the base station 1240, relay information indicating that the UE is selected as the relay for communication between the M-UE 1230 and the base station 1240, at 1268 and 1270. In an aspect, the relay information includes a connection identifier that is used for receiving communication from the M-UE 1230. In an aspect, the relay information includes an RRC reconfiguration message used for configuration of the UE to relay communication from the M-UE 1230 or for configuration of a connection state of a communication link between the UE and the M-UE 1230. In such an aspect, the RRC reconfiguration message associates a logical channel at the UE with data from the M-UE 1230 that is being relayed to the base station 1240. The relay information component 1214 may communicate with the connection management component 1210 at 1272 to manage connection via the reception component 1204 at 1276 and the transmission component 1206 at 1274.

A PAR management component 1216 monitors for a PAR message during a predetermined time window, via the reception component 1204, at 1268 and 1278. The PAR management component 1216 receives via the reception component 1204, from the base station 1240, a PAR message to purge the access request that is received from the M-UE 1230 and is not yet forwarded to the base station 1240 (at 1268 and 1278), the PAR message identifying the access request to be purged. The PAR management component 1216 and the access request component 1208 purge the access request based on the PAR message without forwarding the access request to the base station 1240, at 1280. In an aspect, the PAR message includes a device identifier of the M-UE 1230 to identify the access request to be purged. In such an aspect, the device identifier includes at least one of a random bit string, an S-TMSI or a C-RNTI of the M-UE 1230. In an aspect, the PAR message is addressed to a PAR-RNTI.

The apparatus may include additional components that perform each of the blocks of the algorithm in the aforementioned flowcharts of FIGS. 10 and 11. As such, each block in the aforementioned flowcharts of FIGS. 10 and 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

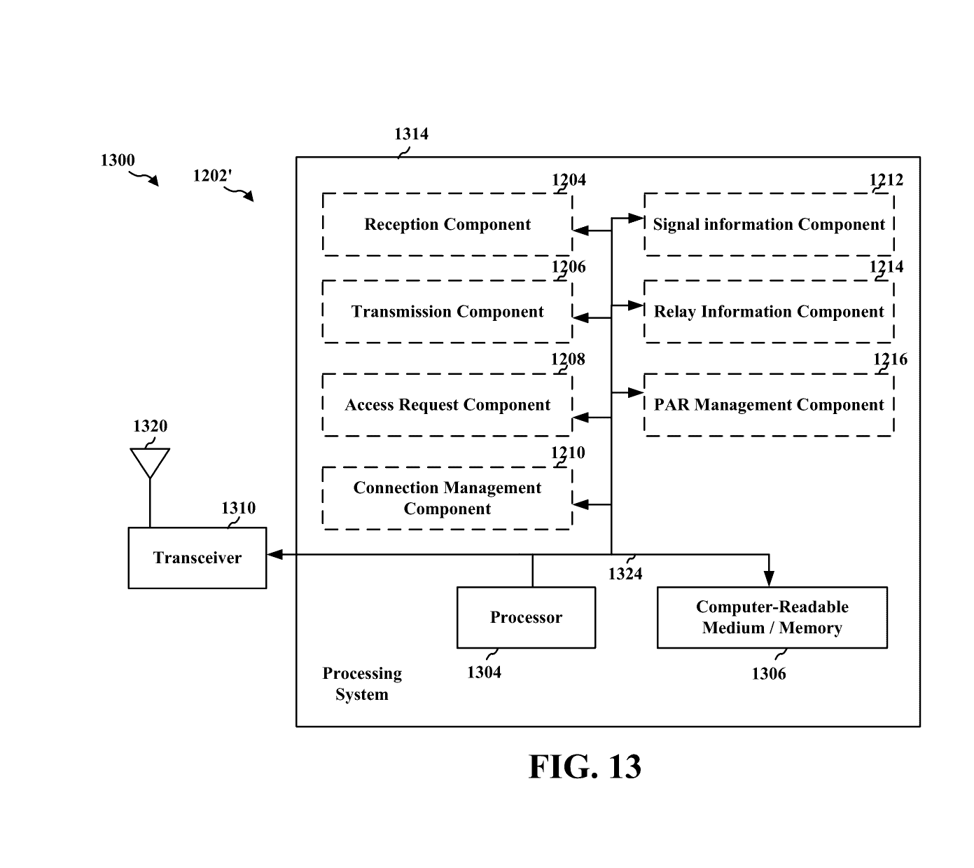

FIG. 13 is a diagram 1300 illustrating an example of a hardware implementation for an apparatus 1202′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware components, represented by the processor 1304, the components 1204, 1206, 1208, 1210, 1212, 1214, 1216, and the computer-readable medium/memory 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The transceiver 1310 receives a signal from the one or more antennas 1320, extracts information from the received signal, and provides the extracted information to the processing system 1314, specifically the reception component 1204. In addition, the transceiver 1310 receives information from the processing system 1314, specifically the transmission component 1206, and based on the received information, generates a signal to be applied to the one or more antennas 1320. The processing system 1314 includes a processor 1304 coupled to a computer-readable medium/memory 1306. The processor 1304 is responsible for general processing, including the execution of software stored on the computer-readable medium/memory 1306. The software, when executed by the processor 1304, causes the processing system 1314 to perform the various functions described supra for any particular apparatus. The computer-readable medium/memory 1306 may also be used for storing data that is manipulated by the processor 1304 when executing software. The processing system 1314 further includes at least one of the components 1204, 1206, 1208, 1210, 1212, 1214, 1216. The components may be software components running in the processor 1304, resident/stored in the computer readable medium/memory 1306, one or more hardware components coupled to the processor 1304, or some combination thereof. The processing system 1314 may be a component of the UE 350 and may include the memory 360 and/or at least one of the TX processor 368, the RX processor 356, and the controller/processor 359.

In one configuration, the apparatus 1202/1202′ for wireless communication includes means for receiving an access request from an M-UE, the access request requesting access to a base station through the apparatus 1202/1202′ as a relay, means for determining whether to forward the access request to the base station, and means for forwarding the access request to the base station upon determining to forward the access request to the base station. The apparatus 1202/1202′ further includes means for determining at least one of an RSRP or an RSRQ of a connection between the M-UE and the apparatus 1202/1202′, and means for transmitting the at least one of the RSRP or the RSRQ to the base station when the access request is forwarded to the base station. The apparatus 1202/1202′ further includes means for entering the RRC connected state with the base station to forward the access request to the base station when the apparatus 1202/1202′ is in an idle state. The apparatus 1202/1202′ further includes means for receiving, from the base station, relay information indicating that the apparatus 1202/1202′ is selected as the relay for communication between the M-UE and the base station. The apparatus 1202/1202′ further includes means for receiving, from the base station, a PAR message to purge the access request that is received from the M-UE and is not yet forwarded to the base station, the PAR message identifying the access request to be purged, means for purging the access request based on the PAR message without forwarding the access request to the base station, and means for monitoring for the PAR message during a predetermined time window.

The aforementioned means may be one or more of the aforementioned components of the apparatus 1202 and/or the processing system 1314 of the apparatus 1202′ configured to perform the functions recited by the aforementioned means. As described supra, the processing system 1314 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

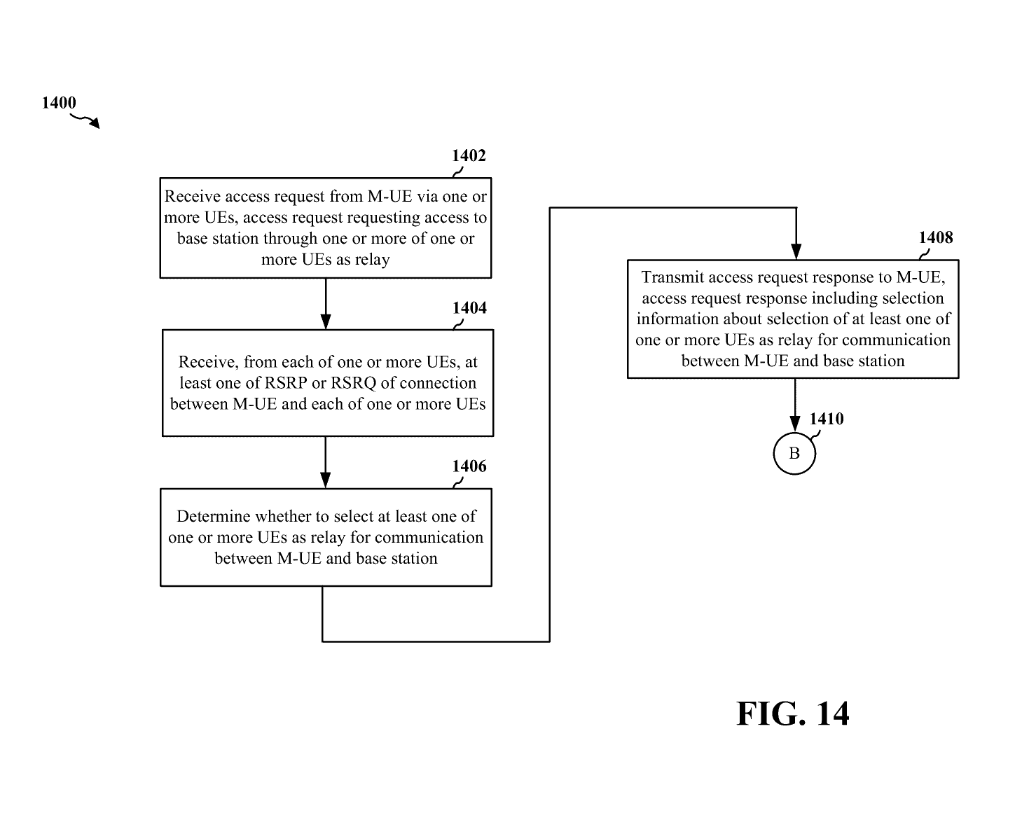

FIG. 14 is a flowchart 1400 of a method of wireless communication. The method may be performed by an eNB (e.g., the eNB 510, the apparatus 1602/1602′). At 1402, the eNB receives an access request from an M-UE via one or more UEs, the access request requesting access to the base station through one or more of the one or more UEs as a relay. For example, as discussed supra, at 514, the D-UE 1 504 that is in a connected state with the eNB 510 forwards the access request to the eNB 510 without much delay. Similarly, for example, as discussed supra, at 516, the D-UE 2 506 that is in a connected state with the eNB 510 forwards the access request to the eNB 510 without much delay.

At 1404, the eNB receives, from each of the one or more UEs, at least one of a RSRP or a RSRQ of a connection between the M-UE and each of the one or more UEs. For example, as discussed supra, when a D-UE (e.g., D-UE 1 504 at 514 or D-UE 2 506 at 516) forwards the access request to the eNB 510, the D-UE forwards the access request along with D2D signal information such as RSRP and/or RSRQ of the D2D connection between the M-UE and the D-UE.

At 1406, the eNB determines whether to select at least one of the one or more UEs as a relay for communication between the M-UE and the base station. For example, as discussed supra, after the eNB 510 receives the access request and the D2D signal information from each of the D-UEs (e.g., D-UE 1 504 and D-UE 2 506), the eNB 510 selects a D-UE among the D-UEs that forwarded the access request, where the selected D-UE is to perform as a relay. For example, as discussed supra, the eNB 510 may not select any of the D-UEs that have forwarded the access request to the eNB 510.

In an aspect, the eNB determines whether to select at least one of the one or more UEs as a relay by determining to select at least one of the one or more UEs as a relay based on the at least one of the RSRP or the RSRQ. In such an aspect, the determining to select the at least one of the one or more UEs as a relay is further based on at least one of a distance between the base station and each of the one or more UEs or signal strength between the base station and each of the one or more UEs. For example, as discussed supra, the eNB 510 may select a D-UE with the best D2D signal information (e.g., highest RSRP and/or RSRQ) among the D-UEs that have forwarded the access request and the D2D signal information to the eNB 510. For example, as discussed supra, in addition to considering the D2D signal information, the eNB 510 may additionally consider a distance between a D-UE and the eNB as well as signal strength of communication between the D-UE and the eNB for selection of a D-UE as a relay.

In an aspect, the determining whether to select at least one of the one or more UEs as a relay includes determining not to select the one or more UEs when each of the at least one of the RSRP or the RSRQ of the connection between the M-UE and each of the one or more UEs is below a minimum threshold. For example, as discussed supra, the eNB 510 may not select any D-UE because the eNB 510 determines that none of the D-UEs that have forwarded the access request may be suitable as a relay. For example, as discussed supra, the eNB may determine that a D-UE is suitable as a relay if the D2D signal information corresponding to the D-UE is above a minimum threshold.

At 1408, the eNB transmits an access request response to the M-UE, the access request response including selection information about selection of at least one of the one or more UEs as a relay for communication between the M-UE and the base station. In an aspect, the selection information includes at least one of a connection identifier, the connection identifier being used for communication between the M-UE and at least one selected UE of the one or more UEs, or an indication that no UE is selected as a relay. In an aspect, the access request response further includes at least one of an access bar command that indicates that the M-UE should not try discovering a network or accessing the network, or a C-RNTI of the M-UE. For example, as discussed supra, if the eNB 510 selects a D-UE as a relay, the eNB 510 sends an ARR message including a D2D C-ID to the M-UE 502, where the D2D C-ID identifies a D-UE that is selected as a relay. For example, as discussed supra, if the eNB 510 does not select any D-UE as a relay, the ARR message may include an indication that no D-UE has been selected as a relay. For example, as discussed supra, in some cases, the ARR message may further include an access bar command that indicates that the M-UE should not try discovering a network or accessing the network. For example, as discussed supra, the ARR message may further include a C-RNTI (physical layer identifier for random access) of the M-UE 502.

In an aspect, the access request response is transmitted to the M-UE during a time window that is known to the M-UE.

At 1410, the eNB may continue to perform additional features as described infra.

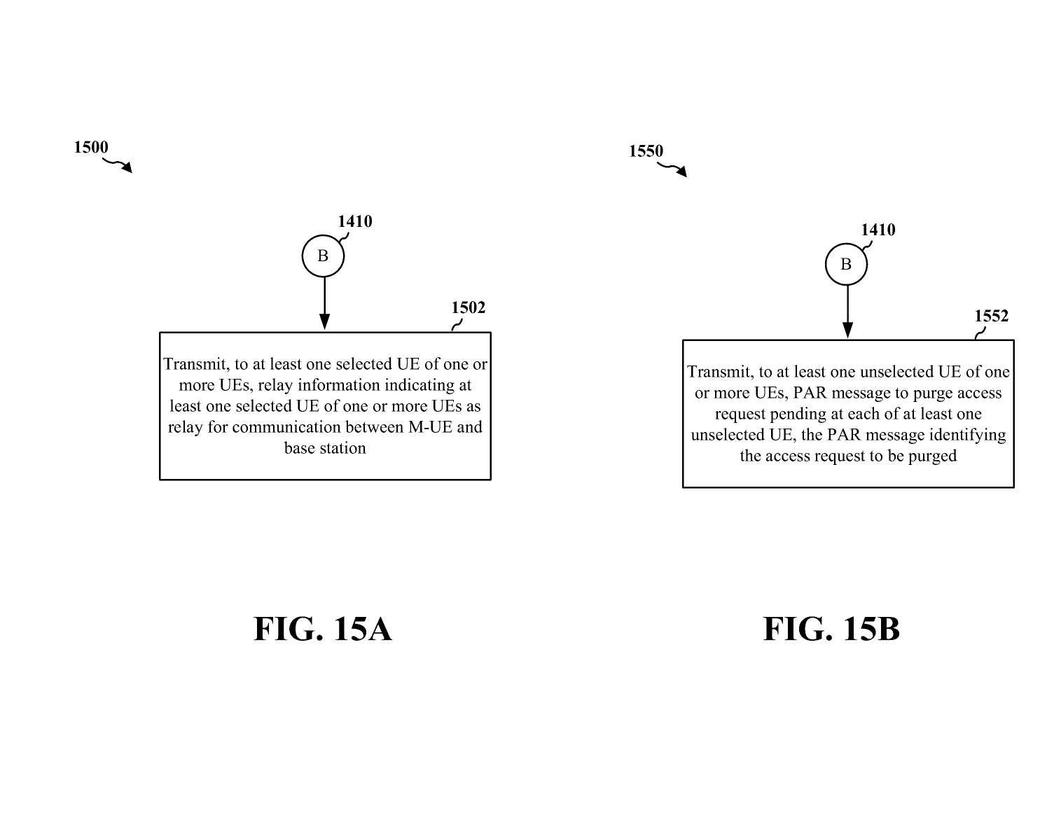

FIG. 15A is a flowchart 1500 of a method of wireless communication, expanding from the flowchart 1400 of FIG. 14. The method may be performed by an eNB (e.g., the eNB 510, the apparatus 1602/1602′). At 1410, the method continues from the flowchart 1400 of FIG. 14. At 1502, the eNB transmits, to the at least one selected UE of the one or more UEs, relay information indicating the at least one selected UE of the one or more UEs as the relay for communication between the M-UE and the base station. In an aspect, the relay information includes a connection identifier that is used for receiving communication from the M-UE. For example, as discussed supra, if the eNB 510 selects a D-UE as a relay, the eNB 510 further sends the D2D C-ID to the D-UE that is selected as a relay.

In an aspect, the relay information includes an RRC reconfiguration message used for at least one of configuration for the at least one selected UE to relay communication from the M-UE or configuration of a connection state of a communication link between the at least one selected UE and the M-UE. In such an aspect, the RRC reconfiguration message associates a logical channel at the at least one selected UE with data from the M-UE that is being relayed to the base station. For example, as discussed supra, after selecting a D-UE as a relay, the eNB 510 may further send an RRC reconfiguration message to the selected D-UE, where the RRC reconfiguration message configures the selected D-UE to relay the messages from M-UE and/or configures a connection state of the D2D link between the M-UE and the selected d-UE. For example, as discussed supra, the RRC reconfiguration message may associate a logical channel at the selected D-UE with the data from the M-UE that is being relayed, such that the data from the M-UE may be forwarded to the eNB under the logical channel.

FIG. 15B is a flowchart 1550 of a method of wireless communication, expanding from the flowchart 1400 of FIG. 14. The method may be performed by an eNB (e.g., the eNB 510, the apparatus 1602/1602′). At 1410, the method continues from the flowchart 1400 of FIG. 14. At 1552, the eNB transmits, to at least one UE of the one or more UEs that is not selected as a relay, a PAR message to purge the access request pending at each of the at least one UE that is not selected as a relay, the PAR message identifying the access request to be purged. For example, as discussed supra, the eNB 510 sends a PAR message to D-UEs that still have a pending access request that has not been forwarded to the eNB, where the PAR message indicates to such D-UEs that the pending access request should be purged.

In an aspect, the PAR message includes a device identifier of the M-UE to identify the access request to be purged. In such an aspect, the device identifier includes at least one of a random bit string, an S-TMSI or a C-RNTI of the M-UE. For example, as discussed supra, the PAR message may include one or more device identifiers (e.g., random string values, S-TMSI, C-RNTI) of the M-UE 502 that are used to identify access requests to be purged.

In an aspect, the PAR message is addressed to a PAR-RNTI. For example, as discussed supra, the eNB 510 may address the PAR message to a new RNTI such as a PAR RNTI. In an aspect, the PAR message is transmitted at one or more PAR occasions during a predetermined time window. For example, as discussed supra, the transmission times of the PAR messages are predefined, and the eNB sends the PAR messages during the predefined transmission times.

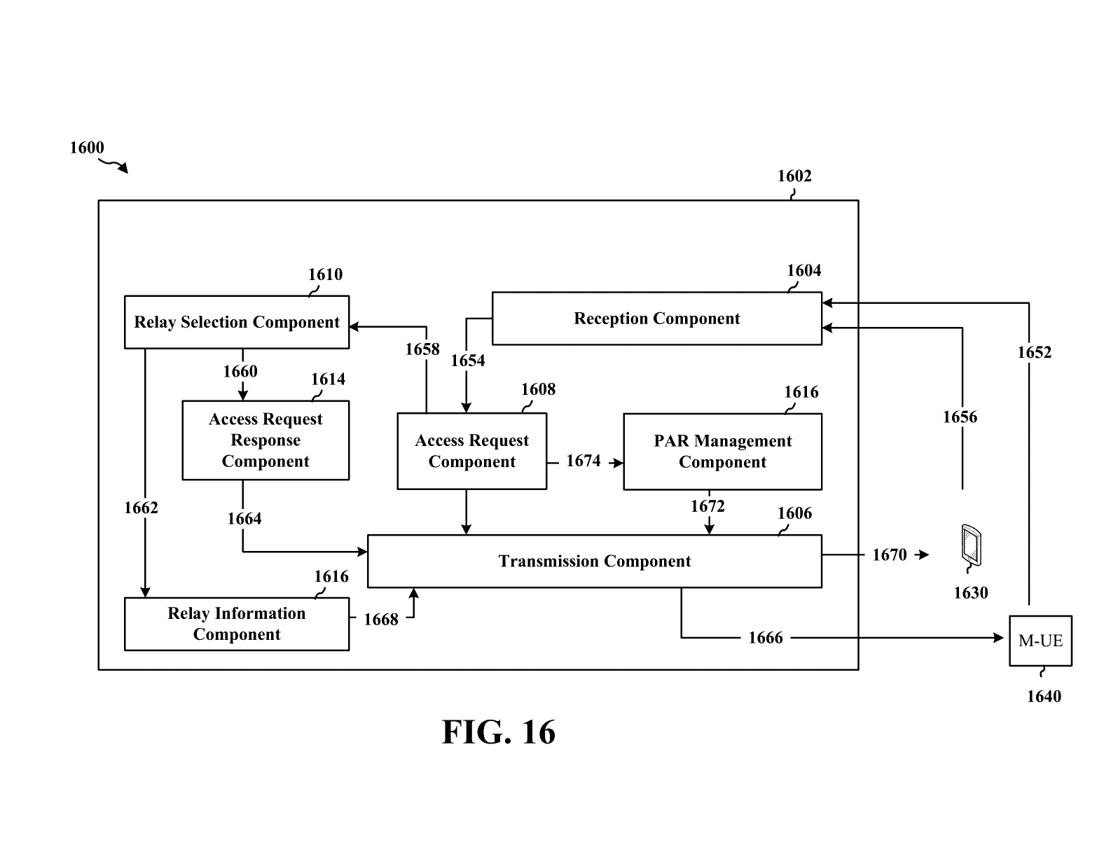

FIG. 16 is a conceptual data flow diagram 1600 illustrating the data flow between different means/components in an exemplary apparatus 1602. The apparatus includes a reception component 1604, a transmission component 1606, an access request component 1608, a relay selection component 1610, an access request response component 1612, a relay information component 1614, and a PAR management component 1616.

The access request component 1608 receives, via the reception component 1604, an access request from an M-UE 1640 via one or more UEs (e.g., the UE 1630), the access request requesting access to the base station through one or more of the one or more UEs as a relay, at 1652 and 1654. The access request component 1608 receives via the reception component 1604, from each of the one or more UEs (e.g., UE 1630), at least one of a RSRP or a RSRQ of a connection between the M-UE 1640 and each of the one or more UEs, at 1656 and 1654. The access request component 1608 may forward information on the RSRP and the RSRP to the relay selection component 1610, at 1658.

The relay selection component 1610 determines whether to select at least one of the one or more UEs as a relay for communication between the M-UE 1640 and the base station. In an aspect, the relay selection component 1610 determines whether to select at least one of the one or more UEs as a relay by determining to select at least one of the one or more UEs as a relay based on the at least one of the RSRP or the RSRQ. In such an aspect, the determining to select the at least one of the one or more UEs as a relay is further based on at least one of a distance between the base station and each of the one or more UEs or signal strength between the base station and each of the one or more UEs. In another aspect, the relay selection component 1610 determines whether to select at least one of the one or more UEs as a relay by determining not to select the one or more UEs when each of the at least one of the RSRP or the RSRQ of the connection between the M-UE 1640 and each of the one or more UEs is below a minimum threshold. The relay selection component 1610 may forward the determination results to the access request response component 1612, at 1660. The relay selection component 1610 may forward the determination results to the relay information component 1614, at 1662.

The access request response component 1612 transmits, via the transmission component 1606, an access request response to the M-UE 1640, the access request response including selection information about selection of at least one of the one or more UEs as a relay for communication between the M-UE 1640 and the base station, at 1664 and 1666. In an aspect, the selection information includes at least one of a connection identifier, the connection identifier being used for communication between the M-UE 1640 and at least one selected UE of the one or more UEs, or an indication that no UE is selected as a relay. In an aspect, the access request response further includes at least one of an access bar command that indicates that the M-UE 1640 should not try discovering the network or accessing the network, or a C-RNTI of the M-UE 1640. In an aspect, the access request response is transmitted to the M-UE 1640 during a time window that is known to the M-UE 1640.

The relay information component 1614 transmits via the transmission component 1606, to the at least one selected UE of the one or more UEs, relay information indicating the at least one selected UE of the one or more UEs as the relay for communication between the M-UE 1640 and the base station, at 1668 and 1670. In an aspect, the relay information includes a connection identifier that is used for receiving communication from the M-UE 1640. In an aspect, the relay information includes an RRC reconfiguration message used for at least one of configuration for the at least one selected UE to relay communication from the M-UE 1640 or configuration of a connection state of a communication link between the at least one selected UE and the M-UE 1640. In such an aspect, the RRC reconfiguration message associates a logical channel at the at least one selected UE with data from the M-UE 1640 that is being relayed to the base station.

The PAR management component 1616 transmits via the transmission component 1606, to at least one UE of the one or more UEs that is not selected as a relay, a PAR message to purge the access request pending at each of the at least one UE that is not selected as a relay, the PAR message identifying the access request to be purged, at 1672. The PAR management component 1616 may information about the access request from the access request component 1608, at 1674. In an aspect, the PAR message includes a device identifier of the M-UE 1640 to identify the access request to be purged. In such an aspect, the device identifier includes at least one of a random bit string, an S-TMSI or a C-RNTI of the M-UE 1640. In an aspect, the PAR message is addressed to a PAR-RNTI. In an aspect, the PAR message is transmitted at one or more PAR occasions during a predetermined time window.

The apparatus may include additional components that perform each of the blocks of the algorithm in the aforementioned flowcharts of FIGS. 14 and 15. As such, each block in the aforementioned flowcharts of FIGS. 14 and 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

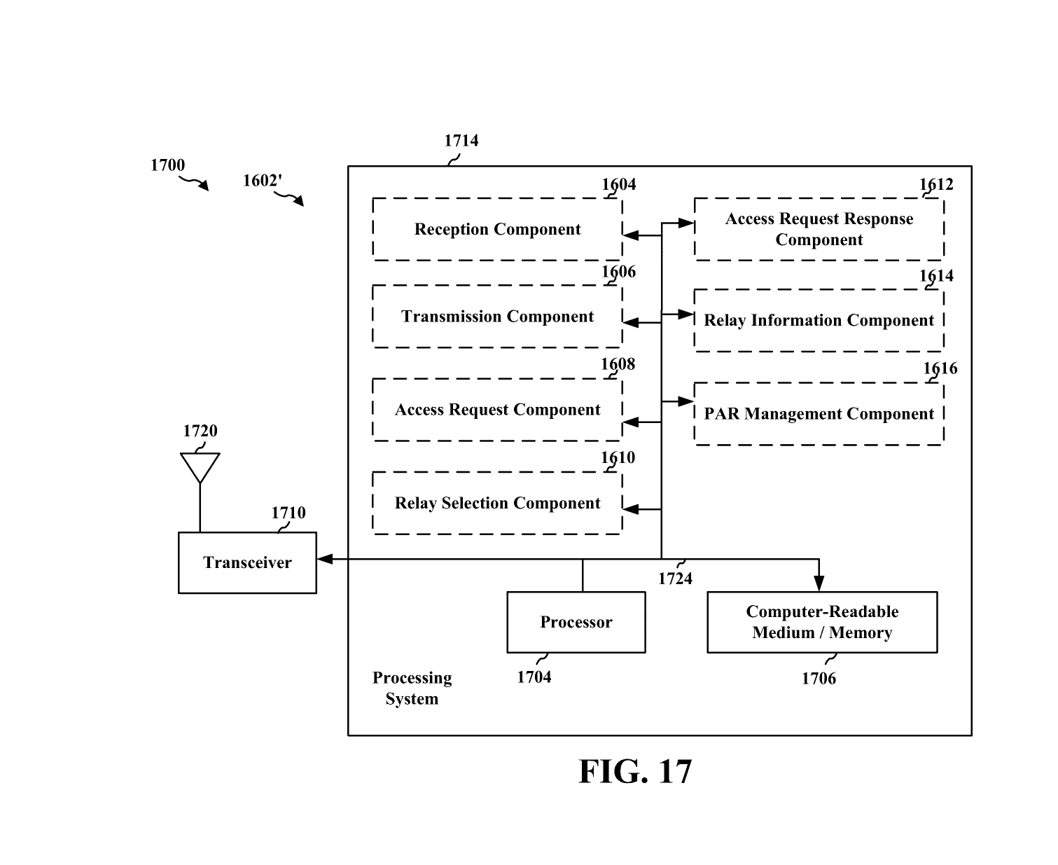

FIG. 17 is a diagram 1700 illustrating an example of a hardware implementation for an apparatus 1602′ employing a processing system 1714. The processing system 1714 may be implemented with a bus architecture, represented generally by the bus 1724. The bus 1724 may include any number of interconnecting buses and bridges depending on the specific application of the processing system 1714 and the overall design constraints. The bus 1724 links together various circuits including one or more processors and/or hardware components, represented by the processor 1704, the components 1604, 1606, 1608, 1610, 1612, 1614, 1616, and the computer-readable medium/memory 1706. The bus 1724 may also link various other circuits such as timing sources, peripherals, voltage regulators, and power management circuits, which are well known in the art, and therefore, will not be described any further.

The processing system 1714 may be coupled to a transceiver 1710. The transceiver 1710 is coupled to one or more antennas 1720. The transceiver 1710 provides a means for communicating with various other apparatus over a transmission medium. The transceiver 1710 receives a signal from the one or more antennas 1720, extracts information from the received signal, and provides the extracted information to the processing system 1714, specifically the reception component 1604. In addition, the transceiver 1710 receives information from the processing system 1714, specifically the transmission component 1606, and based on the received information, generates a signal to be applied to the one or more antennas 1720. The processing system 1714 includes a processor 1704 coupled to a computer-readable medium/memory 1706. The processor 1704 is responsible for general processing, including the execution of software stored on the computer-readable medium/memory 1706. The software, when executed by the processor 1704, causes the processing system 1714 to perform the various functions described supra for any particular apparatus. The computer-readable medium/memory 1706 may also be used for storing data that is manipulated by the processor 1704 when executing software. The processing system 1714 further includes at least one of the components 1604, 1606, 1608, 1610, 1612, 1614, 1616. The components may be software components running in the processor 1704, resident/stored in the computer readable medium/memory 1706, one or more hardware components coupled to the processor 1704, or some combination thereof. The processing system 1714 may be a component of the eNB 310 and may include the memory 376 and/or at least one of the TX processor 316, the RX processor 370, and the controller/processor 375.

In one configuration, the apparatus 1602/1602′ for wireless communication includes means for receiving an access request from an M-UE via one or more user UEs, the access request requesting access to the apparatus 1602/1602′ through one or more of the one or more UEs as a relay, means for determining whether to select at least one of the one or more UEs as a relay for communication between the M-UE and the apparatus 1602/1602′, and means for transmitting an access request response to the M-UE, the access request response including selection information about selection of at least one of the one or more UEs as a relay for communication between the M-UE and the apparatus 1602/1602′. The apparatus 1602/1602′ further includes means for receiving, from each of the one or more UEs, at least one of an RSRP or an RSRQ of a connection between the M-UE and each of the one or more UEs, where the means for determining whether to select at least one of the one or more UEs as a relay is configured to determine to select at least one of the one or more UEs as a relay based on the at least one of the RSRP or the RSRQ of the connection between the M-UE and each of the one or more UEs. In an aspect, the means for determining to select the at least one of the one or more UEs as a relay is configured to determine to select the at least one of the one or more UEs as a relay further based on at least one of a distance between the apparatus 1602/1602′ and each of the one or more UEs or signal strength between the apparatus 1602/1602′ and each of the one or more UEs. The apparatus 1602/1602′ further includes means for determining to select the at least one of the one or more UEs as a relay is configured transmitting, to the at least one selected UE of the one or more UEs, relay information indicating the at least one selected UE of the one or more UEs as the relay for communication between the M-UE and the apparatus 1602/1602′. In an aspect, the means for determining whether to select at least one of the one or more UEs as a relay is configured to determine not to select the one or more UEs when each of the at least one of the RSRP or the RSRQ of the connection between the M-UE and each of the one or more UEs is below a minimum threshold.

The apparatus 1602/1602′ further includes means for determining to select the at least one of the one or more UEs as a relay is configured transmitting, to at least one UE of the one or more UEs that is not selected as a relay, a PAR message to purge the access request pending at each of the at least one UE that is not selected as a relay, the PAR message identifying the access request to be purged.

The aforementioned means may be one or more of the aforementioned components of the apparatus 1602 and/or the processing system 1714 of the apparatus 1602′ configured to perform the functions recited by the aforementioned means. As described supra, the processing system 1714 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication by a machine-type communication user equipment (M-UE), comprising:
transmitting, to one or more user equipments (UEs), an access request to request access to a base station through one or more of the one or more UEs as a relay; and
receiving an access request response from the base station, the access request response including selection information about selection of the at least one of the one or more UEs as a relay between the M-UE and the base station.

2. The method of claim 1, wherein the access request is transmitted by transmitting a discovery message including the access request to the one or more UEs as a relay.

3. The method of claim 2, wherein the discovery message includes at least one of:
downlink (DL) channel quality information;
a device identifier of the M-UE;
a cell identifier of a cell that the M-UE is camped on or connected to;
a radio resource control (RRC) configuration request; or
a buffer status report (BSR).

4. The method of claim 3, wherein the device identifier includes at least one of a random bit string, a system architecture evolution temporary mobile subscriber identity (S-TMSI) or a cell radio network temporary identifier (C-RNTI) of the M-UE.

5. The method of claim 2, wherein the discovery message is transmitted during a discovery resource pool, the discovery resource pool being identified in a system information block (SIB) message received from the base station.

6. The method of claim 1, wherein the selection information includes at least one of a connection identifier, the connection identifier being used for communication between the M-UE and at least one selected UE of the one or more UEs, or an indication that no UE is selected as a relay.

7. The method of claim 6, wherein the access request response further includes at least one of:
an access bar command that indicates that the M-UE should not try discovering a network or accessing the network; or
a cell radio network temporary identifier (C-RNTI) of the M-UE.

8. The method of claim 1, further comprising:
performing uplink communication with the base station through at least one selected UE of the one or more UEs as a relay based on the selection information.

9. A method of wireless communication by a user equipment (UE), comprising:
receiving an access request from a machine-type communication user equipment (M-UE), the access request requesting access to a base station through the UE as a relay;
determining whether to forward the access request to the base station; and
forwarding the access request to the base station upon determining to forward the access request to the base station.

10. The method of claim 9, wherein the access request is received in a discovery message from the M-UE.

11. The method of claim 10, wherein the discovery message includes at least one of:
downlink (DL) channel quality information;
a device identifier of the M-UE;
a cell identifier of a cell that the M-UE is camped on or connected to;
a radio resource control (RRC) configuration request; or
a buffer status report (BSR).

12. The method of claim 11, wherein the device identifier includes at least one of a random bit string, a system architecture evolution temporary mobile subscriber identity (S-TMSI) or a cell radio network temporary identifier (C-RNTI) of the M-UE.

13. The method of claim 9, further comprising:
determining at least one of a reference signal received power (RSRP) or a reference signal received quality (RSRQ) of a connection between the M-UE and the UE; and
transmitting the at least one of the RSRP or the RSRQ to the base station when the access request is forwarded to the base station.

14. The method of claim 9, wherein the access request forwarded to the base station when the UE is in a radio resource control (RRC) connected state with the base station.

15. The method of claim 14, further comprising:
entering the radio resource control (RRC) connected state with the base station to forward the access request to the base station when the UE is in an idle state.

16. The method of claim 9, further comprising:
receiving, from the base station, relay information indicating that the UE is selected as the relay for communication between the M-UE and the base station.

17. The method of claim 16, wherein the relay information includes a connection identifier that is used for receiving communication from the M-UE.

18. The method of claim 16, wherein the relay information includes a radio resource control (RRC) reconfiguration message used for configuration of the UE to relay communication from the M-UE or for configuration of a connection state of a communication link between the UE and the M-UE.

19. The method of claim 18, wherein the RRC reconfiguration message associates a logical channel at the UE with data from the M-UE that is being relayed to the base station.

20. The method of claim 9, further comprising:
receiving, from the base station, a purge access request (PAR) message to purge the access request that is received from the M-UE and is not yet forwarded to the base station, the PAR message identifying the access request to be purged; and
purging the access request based on the PAR message without forwarding the access request to the base station.

21. The method of claim 20, further comprising:
monitoring for the PAR message during a predetermined time window.

22. The method of claim 20, wherein the PAR message includes a device identifier of the M-UE to identify the access request to be purged.

23. The method of claim 22, wherein the device identifier includes at least one of a random bit string, a system architecture evolution temporary mobile subscriber identity (S-TMSI) or a cell radio network temporary identifier (C-RNTI) of the M-UE.

24. The method of claim 21, wherein the PAR message is addressed to a PAR radio network temporary identifier (PAR-RNTI).

25. A method of wireless communication by a base station, comprising:
receiving an access request from a machine-type communication user equipment (M-UE) via one or more user equipments (UEs), the access request requesting access to the base station through one or more of the one or more UEs as a relay;
determining whether to select at least one of the one or more UEs as a relay for communication between the M-UE and the base station; and
transmitting an access request response to the M-UE, the access request response including selection information about selection of at least one of the one or more UEs as a relay for communication between the M-UE and the base station.

26. The method of claim 25, further comprising:
transmitting, to at least one UE of the one or more UEs that is not selected as a relay, a purge access request (PAR) message to purge the access request pending at each of the at least one UE that is not selected as a relay, the PAR message identifying the access request to be purged.

27. The method of claim 26, wherein the PAR message includes a device identifier of the M-UE to identify the access request to be purged, and
wherein the device identifier includes at least one of a random bit string, a system architecture evolution temporary mobile subscriber identity (S-TMSI) or a cell radio network temporary identifier (C-RNTI) of the M-UE.

28. The method of claim 26, wherein the PAR message is addressed to a PAR radio network temporary identifier (PAR-RNTI).

29. The method of claim 26, wherein the PAR message is transmitted at one or more predetermined PAR occasions during a predetermined time window.

30. A machine-type communication user equipment (M-UE) for wireless communication, comprising:
a memory; and
at least one processor coupled to the memory and configured to:
transmit, to one or more user equipments (UEs), an access request to request access to a base station through one or more of the one or more UEs as a relay; and
receive an access request response from the base station, the access request response including selection information about selection of at least one of the one or more UEs as a relay between the M-UE and the base station.
